(19) United States
(12) Patent Application Publication
(10) Pub. No.: US 2012/0018085 A1
(43) Pub. Date: Jan. 26, 2012

(54) Tape Dispenser Apparatus

(76) Inventor: Michael Frederick Renkert, Denver, CO (US)

(21) Appl. No.: 13/253,057

(22) Filed: Oct. 4, 2011

Related U.S. Application Data
(63) Continuation-in-part of application No. 12/840,298, filed on Jul. 21, 2010.

(51) Int. Cl. B32B 37/24; B32B 37/12; B32B 38/10

(52) U.S. Cl. 156/242; 156/523

(57) ABSTRACT

An apparatus and method for a tape dispenser apparatus includes a first housing and tape rotational hub, a tape aperture feeding into a tape channel for a tape guide, also a cutter aperture disposed within the channel, and a cutter pivotally attached to the first housing, wherein the cutter extends therethrough the cutter aperture in a cutting state and the cutter retracts from the cutter aperture being urged into a retracted state. A roller rotatably attached to the first housing, the roller is positioned adjacent to a non-adhesive side of the tape, wherein the roller routes the strip of tape around the cutter to feed the strip of tape into the tape aperture and tape channel. Operationally the tape channel is positioned adjacent to a surface and the apparatus is pulled to lay the strip of tape upon the surface, wherein the tape is selectively cut by the cutter.

### RELATED APPLICATIONS

This continuation in part (CIP) patent application claims priority from U.S. patent application Ser. No. 12/840,298 filed on Jul. 21, 2010 by Michael Frederick Renkert of Denver, Colo., that claims priority of United States patent application Ser. No. 12/313,084 filed on Nov. 17, 2008 by Michael Frederick Renkert of Denver, Colo., US, that claims priority of U.S. provisional patent application (PPA) Ser. No. 61/003,776 filed on Nov. 20, 2007 by Michael Frederick Renkert of Denver, Colo., US.

### TECHNICAL FIELD

The present invention is broadly related to the building construction industry for providing a smooth and even caulking bead as between articles. More particularly, the present invention is a tape dispenser apparatus that lays a lengthwise line of tape adjacent to an adjoining corner of the planar articles at a consistent spacing from a corner, wherein a lengthwise bead of caulk is applied to the corner partially covering the tape, and a ball is dragged lengthwise upon the caulk bead forcing the caulk bead into the corner leaving a smooth fillet of caulk in the corner, wherein the tape is removed giving the smooth fillet of caulk a straight edge upon the planar article, resulting in a lengthwise smooth and straight bead of caulk as between the adjoining corner of the planar articles.

### BACKGROUND OF THE INVENTION

The present invention relates to an apparatus and method of smoothing, forming, and finishing caulking, similar compounds, or other materials that are applied onto or between planar articles, wherein the caulk is pliable plastic, viscous, or wet but then dries to form an adhering barrier on or between the planar articles for the purpose of sealing, filling, or reforming a void between the planar articles. The building construction field is a common context in which such sealing and adhering materials as described above are used. Often caulking or similar materials are applied to surfaces to provide a visual effect or barrier when a void exists between two such surfaces. Most often, caulking or related materials are applied between two surfaces that oppose each other at approximately ninety degrees. Often such adhering or sealing material is used in the construction of bathrooms and kitchens, where water is typically present, however, not limited to such applications.

A similar instance of a need to seal and fill between two article surfaces is in the case of “chinking” between the surfaces of logs on a log cabin. Just as caulking is applied as a wet, viscous material, so is the sealant used to fill the gaps between logs in a cabin. Another example is sealing a gap around a window, a door frame, or a skylight. As long as two surfaces that are generally parallel have a space between them that needs to be sealed, a viscous adherent can be used to seal the gap between them.

Looking to the prior art, many caulking tools have been designed for the purpose of smoothing or finishing rough caulking or similar material beads after such material has been applied to surfaces requiring such material, which typically include corners but sometimes include surfaces of other shapes or just voids that need to be filled. Typically, current caulking tools consist of a wedge, spoon, or related angled shape on the end of a handle or applicator that can fit into a corner. They are made of plastic, rubber, or other materials, and they all attempt to perform the act of smoothing and removing excess caulking material in the same general manner, for the purpose of creating a uniformly shaped finished bead that is visually pleasing and as well as effective as a barrier against anything that can cause damage or is simply not desired to be visually present in a void or crack. By placing the intended smoothing or finishing head of a typical caulking tool in a corner or area that has a rough caulking or similar bead present, the rough bead is smoothed and spread more evenly by dragging the caulking tool, guided by the walls intersecting at the corner where the rough caulking tool has been applied.

There are flaws in previously designed caulking tools. One is that they can allow for a finished caulking bead of variable volume, consistency, and thickness. This inconsistent finish is achieved by irregular motion of the hand that moves the tool from more than one physical orientation. The flat or curved head of a tool can be oriented in a corner at more than one angle, and as the hand holding the tool shakes or changes position, so does the angle of the tool. An example of this would be a triangle with rounded corners that do not touch the axis of the corner while it touches both surfaces perpendicularly. If the tool is moved to a 45-degree angle, its tip is farther from the axis than when it was oriented perpendicularly to each surface. If the same tool held at a 3D-degree angle, the tip of the tool, which is intended to do most of the finishing effect, is even farther from the axis of the surfaces.

Thus, as the orientation and angle of the tool changes as it is dragged over a rough caulking bead, so does the thickness and volume of the finished caulking bead. Another problem with the typical caulking tool utilizing a wedge, spoon, or related angled shape is the fact that the tip of the tool can actually get closer to the axis or interface of two surfaces through the act of twisting the tool. As the tool turns and becomes closer to parallel to the surfaces, its tip goes closer to the axis. This allows for more caulking or similar material to be removed than desired. Another problem with existing manual caulking tools is what is referred to here as “plow effect”. This “plow effect” is created as the tool is dragged over the roughly applied caulking material in attempt to smooth it out, excess caulking that comes in contact with the caulking tool is scraped up and pushed along much like snow in front of a snow plow. This often has the effect of spreading caulking wider than desired or into bumps and cracks beyond the surface area that was intended to receive the caulking material.

Another flaw with previously designed caulking tools is the fact that there is no easy way to clean up caulking material that has been “plowed” beyond the area desired to receive the caulk. It must be wiped or washed or scraped, and as a particularly sticky material, this is a difficult, time-consuming process that often allows the opportunity to disturb the previously finished caulking bead. Further, in the case of a rag, finger, sponge, rubber, or similar soft applicator, these tools can be oriented variably and pushed deeper or shallower into the corner than desired by varying force, having the effect of smearing or digging out too much or leaving behind more caulking material than desired. This results from different amounts force being applied to the finishing tool as toward the axis or interface of the surfaces.

Stopping any previously designed caulking or similar finishing tool at a location along the rough bead from moving creates the difficult situation of having to reorient the tool at the same depth and angle, or the next area of the bead will not be finished in the same manner as the bead finished before stopping, especially due to the elastic/plastic nature of the typical caulking material. Another problem with current tools in this area is that when caulking around a bend, such as in the corner between two shower walls or around a round sink, the orientation of current caulking finish tools must remain consistently oriented to the axis or surface interface for the entire distance around such a curve, or the consistency of the bead can be disturbed, wherein keeping the caulking finish tool consistently oriented to the axis or surface interface around the bend can be difficult to do.

Looking to the specific prior art, in U.S. Pat. No. 5,759,342 to Luhman, et al., disclosed is a hand-held tape dispenser having a tape support hub and a support frame, further a brake assembly is pivotally mounted on the frame, and has a curved brake actuator and flat brake plate. The brake plate in Luhman, et al., is aligned to engage a tape roll mounted on the tape support hub and inhibit its free rotation (and dispensing) according to an operator's selection of applied pressure. The Luhman et al., brake plate bends about the tape roll as pressure is increased to facilitate tape cutting or tape stretching (in the case of stretchable tape in the dispenser). Note that the tape cutter in Lehman et al., is a conventional saw-tooth type, wherein the tape is dispensed sticky side down via a roller.

Continuing in the prior art in U.S. Pat. No. 7,441,581 to Pitzen disclosed a tape application apparatus that is adapted for both left-handed and right-handed use when applying tape from a roll to a first surface. An edge in Pitzen of the first surface is common to an edge of an adjacent second surface. The tape application apparatus includes a housing and a tape hub attached to the housing that is capable of slidably receiving the roll. The housing in Pitzen has first and second exterior surfaces and first and second interior surfaces and is capable of receiving the roll. When the tape application apparatus in Pitzen is guided in a first direction, the roll is moveable to a first dispensing position against the first interior side surface, and when the tape application apparatus is guided in a second direction opposite the first direction, the roll is moveable to a second dispensing position against the second interior side surface.

Further, in the prior art in U.S. Pat. No. 6,684,926 to Matechuk, disclosed is a hand applicator for adhesive tape that addresses and solves the problems of the application of adhesive tape by hand or any other applicator that is currently on the market. Matechuk is designed to apply adhesive tape smoothly and easily with only the rubber bands of the rollers allowing sensitive pressure firmly to a surface to be masked. Therefore in Matechuk, stripping the tape is very easy as the tape is adhered only on both edges and not the entire width of the tape, wherein the ease of installing a roll of adhesive masking tape on the invention and running the machine along the trim, the machine dispenses the masking tape in a uniform line that is required. With a push of a thumb in Matechuk the masking tape is neatly cut leaving a free end of the roll to begin the next application and the cutting blade in the retracted position allows handling of the machine without the fear of injury. The Matechuk machine is designed to use an adjacent wall or trim as a guide without marking or scarring of walls, further an extension handle will be available to be attached to the machine for applying adhesive tape to baseboards without having to get down on your hands and knees. However, in Matechuk the rollers do rub as against the adjacent wall, see FIG. 1, to align the tape lay-down lengthwise via rotating and moving lengthwise, thus adding potential for scarring the adjacent wall surface by having two axes of movement as against the adjacent wall surface, instead of for instance a static protrusion that would only have one axis of movement as against the adjacent wall surface.

Also, in Matechuk the handle has a trigger to cut the tape, with an additional kit to allow the machine to apply different widths of adhesive tapes, further the adjustable tension on the tape wheel is to allow the operator while holding the machine with one hand, to pull a length of adhesive tape and cut the tape with the cutter to mask light switches, plug covers, or any other items that will require short pieces of tape, etc. The tension in Matechuk prevents the tape wheel from spinning and allowing the cutter to penetrate and cut the adhesive tape into short pieces when required. The Matechuk machine is designed to be easily operated by any do-it-yourself person and or tradesman which does not require any special skills, and the simplicity of the invention may be easily manufactured and be sold at a low and reasonable cost to the potential consumer who will be the beneficiary of a tool which will save them precious time and frustration in applying adhesive masking tape, see column 1, lines 32-67, and column 2, lines 1-3.

Continuing, in U.S. Pat. No. 6,478,068 to Brown disclosed is an apparatus for applying tape such as masking tape to surfaces for purposes of protecting those surfaces from exposure to subsequent treatment of adjacent surfaces by paint, varnish, stain, and the like. The device in Brown of the instant invention includes a rotatably mounted spool of tape which is fed past a cutter blade, over a guide pin and around an application roller. The cutter blade in Brown is positioned to be clear of the tape during normal operation, however, when the tape is tensioned by braking the rotation of the tape spool by application of a hand brake, the tape path is drawn down into contact with the blade, thereby severing it. Additionally, in Brown, the instant invention utilizes a plurality of guide wheels 130 and 135 to space the tape that is deposited by the instant invention apart from the surface that is adjacent to the taped surface, which overcomes Matechuk's potential for scarring the adjacent wall surface as previously described.

Next, in U.S. Pat. No. 4,196,028 to Mills, et al. disclosed a portable taping tool for applying tape over joints in wallboard, sheet rock, gypsum board, drywall, and the like. The Mills, et al. taping tool is light weight and can hold as much joint compound as previous taping tools weighing many times more. The invention in Mills, et al. has a main frame which has a dispensing chamber for joint compound, a mounting for a roll of tape, main rollers, a second roller, and a tape cutting blade. In one embodiment in Mills, et al., the second roller is a corner roller that not only creases the tape but also squares it in the corner. The corner roller can be either rigidly supported in a forward, extended position or spring biased in its forward, extended position. In another embodiment in Mills, et al., the second roller is substantially cylindrical and has a slightly concave shape to its rolling surface. The cylindrical, second roller of the embodiment in Mills, et al. is used to apply tape over flat joints and its slightly concave shape serves to concentrate the joint compound toward the middle of the tape so that the joint compound will be more evenly distributed when the tape is wiped down.

The tape cutting blade in each of the embodiments of Mills, et al. is supported to move along a path between the main rollers and the second roller, in this manner, the tape can be more easily seen and more accurately cut to fit the wallboard section, corner joint, or ceiling joint. Further, in Mills, et al., with this arrangement, the end of the freshly cut tape will still extend outwardly of the taping tool beyond the main rollers so that the taping tool can be manipulated to apply the tape to a new section without having to manually restring the tape about the main rollers. The invention in Mills, et al., also includes the addition of rollers at the tape inlet and tape outlet of the dispensing chamber so that the tape may more easily pass through the dispensing chamber. The taping tool of the present invention in Mills, et al., is much lighter than past tools and it is contemplated that the taping tool of the present invention could be made in part or entirely out of plastic to even further reduce its weight, see column 2, lines 64-68, and column 3, lines 1-34.

Further, in U.S. Pat. No. 7,793,378 to Kirby teaches a combination tool for tile installation that is essentially a “V”-shaped profiler for grout and caulk that uses a series of different sized spheres, see FIG. 7, wherein the termed spherical member 42 is designed to create an aesthetic finishing touch, see column 6, lines 25-37. Thus, Kirby teaches the use of different size spheres or balls to smooth a caulk line, however, Kirby does not teach the use of edging tape of any type of specific tape dispenser. Also, in United States patent application publication number 2008/0085366 to Lian et al., teaches a method for caulking or grouting a corner using special tape that has two adhesive strips, wherein the adhesive strips are parallel to one another and spaced apart from one another, thus when the tape is placed into a corner, the spaced apart adhesive strips remain on each side of the corner forming a lengthwise space to receive the caulk or grout, see FIG. 2. Lian et al., does not teach the use of spheres for smoothing the grout, see paragraph 23 and FIG. 7 element 26, nor does Lian et al., teach a tape dispenser, as Lian et al., utilizes a special tape roll.

What is needed is a tape dispenser apparatus that can precisely place a lengthwise run of tape upon the first and second surfaces a set and controlled distance from a corner interface of the first and second surfaces, wherein the tape can be selectively cut in a safe manner. The tape dispenser apparatus will place the lengthwise run of tape adhesive side down with a cutting blade operable within a safety housing, wherein the cutting blade is normally (default) stored completely within the safety housing and when the cutting blade is extended out of the safety housing to cut the tape, the cutting blade is within a gauged channel to help prevent user injury and to prevent scarring of the first and second surfaces, further, the cutting blade has a blunt leading edge for user safety, wherein the leading edge is at an angle to assist in cutting the tape.

Wherein functionally the tape dispenser apparatus is an improved method of finishing a rough bead of caulking or related materials after it has been applied to an area requiring such treatment. Caulking and other materials that are applied in a wet or viscous form for the purpose of creating a barrier and aesthetic effect have interior and exterior applications. Interior applications include use as a barrier between corners of various sizes and angles, gaps between walls and fixtures, surfaces, features, fixtures, walls, floors, and cracks or generally any two surfaces that intersect or come close to each other, that create a crack, interface, or void between them needs to be filled and protected. Exterior applications include corners, gaps between surfaces such as logs, (used as a “chinking” tool for log cabins and similar structures,) staircases, cracks, windows, skylights, etc., or any surfaces or features that intersect or come close to each other and create a crack or void that needs to be filled or protected. Similar applications might utilize other materials such as grouting, spackle, paint, glue, foam, cement, and other compounds that are applied as a barrier or aesthetic effect between two surfaces.

A freshly applied bead or volume of caulking or other similar adhesive material that is applied as a barrier or adherent is often squeezed out or applied by hand at an inconsistent rate and volume leaving a roughly shaped volume of such material and often not entirely on the location that is intended to receive it. Thus a “finishing” tool can be used to smooth out and reform the rough mass of applied material while forcing the applied material in the area that is intended to receive it.

The present invention of the tape dispenser apparatus captures and utilizes the physical relationship that exists between a forming ball with a specific radius and the infinite contact points it creates when it touches and slides or rolls on two surfaces that are generally parallel at an axis, angle, or edge. The characteristics of this geometrical arrangement are beneficial as the mathematical basis of a set of tools used for finishing, manipulating, or forming a freshly applied bead of caulking or other viscous, plastic, pliable, or wet materials used for creating an adhering barrier on and or between the adjacent surfaces. The desired tape dispenser apparatus invention described introduces a spherical or ball-shaped forming tool with a handle or other method of manipulating it as a finisher of a rough or wet caulking bead or other material applied for the purpose of creating the barrier.

The present invention of the tape dispenser apparatus applies a ribbon of tape or similar material onto and parallel to the line established by contact point protrusions on the exterior of the tape dispenser being in slidable contact with the planar surfaces for the purpose of creating the gauged lengthwise tape edge spaced out from the corner as between the planar surfaces thus creating a strip of exposed surface wherein the caulk is applied. Thus the present invention tape dispenser apparatus applies the tape or ribbon in a selected lengthwise strip which is determined by the radius of the forming ball and the contact points it creates when touching both of the adjacent tape faces applied lengthwise on the surfaces. The tape or similar material being dispensed by the tape dispenser apparatus has a mathematical relationship with the size of finished caulk bead desired and thus the size of finishing forming tool radius that is used which establishes the distance from the corner created by the surfaces to which the adhesive tape needs to be applied in a lengthwise manner. Though the sizes of the finished caulk bead fillet, the finishing forming tool and tape distance from the corner of the surfaces can be of any dimensions, the relationship between them is always relatively specific. The size of the desired finished caulk fillet bead determines which spherical smoothing forming tool is used, and the radius of that spherical smoothing forming tool head determines where the applied lengthwise line of tape is applied distance wise from the surfaces corner as a barrier to excess caulking material.

Additionally, the invention relates to a method of applying the adhesive tape or other similar material to such surfaces, so as to set a barrier that does not permit caulking or similar material to adhere to surfaces where not desired and to allow easy removal of excess applied material. The preferred embodiment of the present invention tape dispenser apparatus is one that utilizes the relationship between the contact points of the forming ball as a forming tool of a smooth and even fillet of caulk being of a certain size or multiplicity of sizes via the forming ball contacting two surfaces that are relatively parallel and the tape dispenser apparatus that can apply tape parallel and lengthwise to a line of those contact points along the corner on both sides of the real or projected intersection corner of the surfaces for the purpose of forming and smoothing a caulking fillet or other type of sealing or adhering bead.

### SUMMARY OF INVENTION

Broadly the present invention of the tape dispenser apparatus includes a first housing portion including a hub for rotatably supporting the roll of tape, wherein the tape rotates about a first rotational axis, the first housing portion also includes a tape aperture feeding into a tape channel that acts as a guide for the strip of tape, further the first housing portion includes a cutter aperture disposed within the channel, also included is a cutter pivotally attached to the first housing portion, wherein the cutter extends therethrough the cutter aperture in a cutting state and the cutter retracts from the cutter aperture being disposed within the first housing portion in a retracted state, wherein the cutter can be selectively placed in the cutting state. Further included in the tape dispenser apparatus is a structure for urging the cutter into the retracted state and a roller that is attached to the first housing portion. Wherein the roller cylindrically positioned about a roller axis that is parallel to the first rotational axis and the roller is positioned such that it is proximate to a non-adhesive side of the tape, wherein operationally the roller routes the strip of tape off of the roll of tape around the cutter to feed the strip of tape into the tape aperture and tape channel. Further operationally, the tape channel is manually positioned adjacent to the surface and the first housing portion is manually pulled in a lengthwise manner to lay the strip of tape upon the surface with the adhesive side of the tape facing outward such that the tape sticks to the surface, wherein the strip of tape is selectively cut by the cutter.

### BRIEF DESCRIPTION OF DRAWINGS

FIG. 1 shows the forming ball of a radius oriented in a corner as between two surfaces, noting that even with omni-directional rotation of the forming ball, the contact points of the ball on the surfaces remain consistent upon the two surfaces for the forming ball with the radius of size;

FIG. 2 shows the forming ball of the radius oriented in a corner as between two surfaces, noting that even with omni-directional rotation of the forming ball, the contact points of the ball on the surfaces remain consistent upon the two surfaces for the forming ball with the radius of size;

FIG. 3A shows a forming ball of a the radius “R” oriented in a corner between two surfaces, noting that even with omni-directional rotation of the forming ball, the contact points of the ball on the surfaces remain consistent upon the two surfaces for the forming ball with the larger specific radius, wherein under the forming ball and in-between the two surfaces the caulk fillet in cross section is formed;

FIG. 3B shows a forming ball of a the radius “R” oriented in a corner between two surfaces, noting that even with omni-directional rotation of the forming ball, the contact points of the ball on the surfaces remain consistent upon the two surfaces for the forming ball with the larger specific radius, wherein under the forming ball and in-between the two surfaces the caulk fillet in cross section is formed;

FIG. 4 shows a perspective view of FIGS. 3A and 3B with the forming ball of radius “R” oriented in the corner as between the two surfaces, as the forming ball moves lengthwise parallel to the corner and the two surfaces while the forming ball is lengthwise slidably contacting both surfaces, the caulk fillet is shaped and formed under the forming ball and in-between the two surfaces, wherein the space beneath the forming ball between the slidable contact lines on the two surfaces remains consistent;

FIG. 5 shows a perspective view of FIGS. 3A and 3B and further FIG. 4 with the modification of the lengthwise corner being curved or non-linear, with the forming ball of radius “R” oriented in the corner as between the two surfaces, as the forming ball moves lengthwise parallel to the corner and the two surfaces while the forming ball is slidably contacting both surfaces, the caulk fillet is shaped and formed under the forming ball and in-between the two surfaces, wherein the space beneath the forming ball between the slidable contact lines on the two surfaces remains consistent;

FIG. 6A shows the forming ball prior to contacting the two surfaces in a slidable manner, being at the point where the caulk bead has just been applied to the corner between the two surfaces, wherein it is shown in cross section the caulk bead is in a rough and uneven state having a free surface that is having multiple undulations;

FIG. 6B shows the forming ball contacting the two surfaces being similar to FIGS. 3A, 3B, 4, and 5, however, showing the addition of the excess caulk material being extruded or pushed from the smooth formed caulk fillet area underneath the forming ball to being outside of the contact points adjacent to the surface where the excess caulk material is deposited while sliding the forming ball lengthwise along the two surfaces, wherein the caulk fillet underneath the forming ball is forced into the corner as between the two surfaces to form a better and stronger seal between the two surfaces;

FIG. 7 shows a perspective view of FIG. 6B that better shows the before and after configuration of the caulk bead as the forming ball slidably contacts the two surfaces with the forming ball contacting the two surfaces being similar to FIGS. 3A, 3B, 4, and 5, however, showing the addition of the excess caulk material being extruded or pushed from the smooth formed caulk fillet area underneath the forming ball to being outside of the contact points adjacent to the surface where the excess caulk material is deposited while sliding the forming ball lengthwise along the two surfaces, wherein the caulk fillet underneath the forming ball is forced into the corner as between the two surfaces to form a better and stronger seal between the two surfaces;

FIG. 8A shows the forming ball prior to contacting the two surfaces in a slidable manner, being at the point where the caulk bead has just been applied to the corner between the two surfaces, wherein it is shown in cross section the caulk bead is in a rough and uneven state having a free surface that is having multiple undulations, note also the tape in cross section is shown being applied lengthwise at a distance from the corner on each of the two surfaces;

FIG. 8B shows the forming ball contacting the two surfaces being similar to FIGS. 3A, 3B, 4, and 5, however, showing the addition of the excess caulk material being extruded or pushed from the smooth formed caulk fillet area underneath the forming ball to being outside of the contact points adjacent to the surface where the excess caulk material is deposited while sliding the forming ball lengthwise along the two surfaces, wherein the caulk fillet underneath the forming ball is forced into the corner as between the two surfaces to form a better and stronger seal between the two surfaces, note also the tape in cross section is shown being applied lengthwise at a distance from the corner on each of the two surfaces, also that the forming ball contacts the two surfaces on the tape that is disposed between the forming ball and the two surfaces;

FIG. 8C is an expanded view from FIG. 8B of the cross section that denotes the tape in cross section as being shown being applied lengthwise at a distance from the corner on one of the two surfaces, also shown is the forming ball contacting the tape on the surface that is disposed between the forming ball and the surface;

FIG. 9 is similar to FIG. 7 with the addition of the tape shown in perspective view as applied lengthwise at a distance from the corner on each of the two surfaces, also that the forming ball contacts the two surfaces on the tape that is disposed between the forming ball and the two surfaces, further the before and after configuration of the caulk bead is shown as the forming ball slidably contacts the lengthwise tape on the two surfaces, showing the excess caulk material being extruded or pushed from the smooth formed caulk fillet area underneath the forming ball to being outside of the contact points adjacent to the tape on the surface where the excess caulk material is deposited on top of the tape while sliding the forming ball lengthwise along the two surfaces, wherein the caulk fillet underneath the forming ball is forced into the corner as between the two surfaces to form a better and stronger seal between the two surfaces;

FIG. 10 shows the FIG. 9 view after the forming ball has moved lengthwise along the surfaces on the tape, wherein the excess caulk is disposed upon the tape that is on the surface, that when the tape with the excess caulk material is removed, what is left is an evenly formed, consistent fillet bead of caulk material formed in the corner between the two surfaces;

FIG. 11 shows a set of the forming ball tools of different radii that include handles, with the forming ball tools going from the small radius to the large radius in size;

FIG. 12 shows an elevation view of another embodiment of the forming ball tool having a scrapper tip for removing old caulk, the handle and a forming ball on the opposing end;

FIG. 13 shows a perspective view of the of the tape dispenser apparatus showing the first housing portion with hub, the second housing portion, the tape aperture, the tape channel, the adhesive side of the tape strip, the non adhesive tape side, and the cutting blade actuator extension, with the cutting blade in the retracted state;

FIG. 14 shows an opposing view perspective view from FIG. 13 of the of the tape dispenser apparatus showing the first housing portion with hub, the second housing portion, the tape aperture, the tape channel, the adhesive side of the tape strip, the non adhesive tape side, with the cutting blade in the retracted state;

FIG. 15 shows a view of the tape dispenser apparatus with the second housing portion removed and tape roll removed, thus exposing the first housing portion and hub, the first rotational axis, the parallel relationship between the first rotational axis and the rotational axis, the roller, the positioning of the roller to be proximate to the non-adhesive side of the tape, plus the cutter, the extension of the cutter, the means for urging the cutter into the retracted operational state, the spring for the means for urging the cutter into the retracted operational state, the tape aperture, and the tape channel;

FIG. 16 shows a view of the tape dispenser apparatus with the second housing portion removed thus exposing the first housing portion and hub, with the tape roll in-place, with the tape strip feed around the roller and into the tape aperture and tape channel with the correct positioning of the tape adhesive side and non-adhesive side, also shown is the first rotational axis, the parallel relationship between the first rotational axis and the rotational axis, the roller, the positioning of the roller to be proximate to the non-adhesive side of the tape, plus the cutter in the retracted operational state, the cutter aperture, the extension of the cutter, the means for urging the cutter into the retracted operational state, the spring for the means for urging the cutter into the retracted operational state, the tape aperture, the tape channel, and the edge of the tape;

FIG. 17 shows a view of the tape dispenser apparatus with the second housing portion removed thus exposing the first housing portion and hub, with the tape roll in-place, with the tape strip feed around the roller and into the tape aperture and tape channel with the correct positioning of the tape adhesive side and non-adhesive side, also shown is the first rotational axis, the parallel relationship between the first rotational axis and the rotational axis, the roller, the positioning of the roller to be proximate to the non-adhesive side of the tape, plus the cutter in the cutting operational state, the cutter aperture, the extension of the cutter, the means for urging the cutter into the retracted operational state, the spring for the means for urging the cutter into the retracted operational state, the tape aperture, the tape channel, and the edge of the tape;

FIG. 18 shows a view of the tape dispenser apparatus with the second housing portion removed thus exposing the first housing portion and hub, with the tape roll in-place, with the tape strip feed around the roller and into the tape aperture and tape channel with the correct positioning of the tape adhesive side and non-adhesive side, also shown is the first rotational axis, the parallel relationship between the first rotational axis and the rotational axis, the roller, the positioning of the roller to be proximate to the non-adhesive side of the tape, plus the cutter in the cutting operational state that is completed, the cutter aperture, the extension of the cutter, the means for urging the cutter into the retracted operational state, the spring for the means for urging the cutter into the retracted operational state, the tape aperture, the tape channel, and the edge of the tape;

FIG. 19 shows a perspective view of the tape dispenser apparatus from the second housing portion side showing the tape aperture, the tape channel, the cutter aperture, the protrusions, and the gage height of the protrusions;

FIG. 20 shows view 20-20 from FIG. 19 giving an expanded view of the cutter end in perspective showing the first housing portion side, the tape aperture, the tape channel, the cutter aperture, the cutter, the blunt edge of the cutter, the extension of the cutter, the cutter extending through the aperture, the movement of the cutter extension that coincides with the cutter for the cutting operational state and the retracted operational state;

FIG. 21 shows cross section cut 21-21 from FIG. 20 to show the internal detail of the cutter, with the second housing portion, the protrusions, plus the cutter in either the retracted operational state or the cutting operational state, the extension of the cutter, the blunt leading edge of the cutter, the means for urging the cutter into the retracted operational state, and the spring for the means for urging the cutter into the retracted operational state;

FIG. 22 shows view 22-22 from FIG. 21 to show the internal detail of the cutter, with the second housing portion, the protrusions, plus the cutter in either the retracted operational state or the cutting operational state, the extension of the cutter, the blunt leading edge of the cutter, the means for urging the cutter into the retracted operational state, and the spring for the means for urging the cutter into the retracted operational state;

FIG. 23 shows a perspective view of the tape dispenser apparatus from the second housing portion side showing the tape aperture, the tape channel, the cutter aperture, the protrusions, and the gage height of the protrusions;

FIG. 24 shows a perspective view of the tape dispenser apparatus from the second housing portion side showing the tape aperture, the tape channel, the cutter aperture, the protrusions, and the gage height of the protrusions; and

FIG. 25 shows a use application perspective view wherein all protrusion embodiments use the protrusions as a gauge to set the distance that the applied tape lengthwise positions itself from the corner of the two surfaces.

### REFERENCE NUMBERS IN DRAWINGS

50 Forming ball
51 Handle of forming ball 50
55 Radius of forming ball 50
56 Scrapper tip for removing old caulk
60 Surfaces that are oriented perpendicularly for forming ball 50
61 Corner intersection between two surfaces 60
65 Contact points as between forming ball 50 and the surfaces 60
70 X point showing starting rotation of the forming ball 50
75 Distance from the corner 500 to the contact point 65
80 X point showing ending rotation of the forming ball 50
85 Caulking material
86 Raw caulk bead of caulking material 85
87 Moving forming ball 50 toward raw caulk bead 86
90 Slidable movement of forming ball 50 lengthwise on the surfaces 60
95 Smooth formed fillet of the caulk bead 86
100 Excess caulk material from smoothing 95 by forming ball 50 that overlaps the tape strip 110
105 Adhesive tape roll
106 Aperture of the adhesive tape roll 105
110 Adhesive tape strip dispensed from adhesive tape roll 105 lengthwise upon surfaces 60
111 Edge of tape 110
112 Adhesive on tape
113 Non-adhesive side of tape
115 Removal of adhesive tape strip from surfaces 60
305 Tape dispenser apparatus
310 First housing portion
315 Hub of the first housing portion 310
320 First rotational axis
325 Tape aperture
330 Tape channel
335 Cutter aperture
340 Cutter
341 Pivotal attachment of the cutter 340 to the first housing portion 310
343 Blunt leading edge of cutter 340
344 Extension of cutter 340
346 Aperture for extension 344
350 Cutter 340 extending therethrough the cutter aperture 335 in a cutting operational state
355 Cutter 340 retracting from the cutter aperture 335 being disposed within the first housing portion 310 in a retracted operational state
360 Means for urging the cutter 340 into the retracted operational state 355
361 Spring for means 360
365 Roller
370 Rotational axis of roller 365
375 Parallel relationship as between the first rotational axis 320 and the rotational axis 370
380 Positioning of roller 365 to be proximate to the non-adhesive side 113 of the tape strip 110
385 Routing of the tape strip 110 off of the tape roll 105 around the cutter 340
390 Feeding the tape strip 110 into the tape aperture 325 and tape channel 330
400 Positioning the tape channel 330 adjacent to the surface 60
405 Pulling the first housing 310 in a lengthwise manner
410 Laying the tape strip 110 upon the surface 60
415 Protrusion
420 Gauge height of protrusion 415 equaling radius 55 equaling distance 75
421 Positioning protrusion 415 as against the surface 60
425 Slidable contact of protrusion upon surface 60
430 Second housing portion

### DETAILED DESCRIPTION

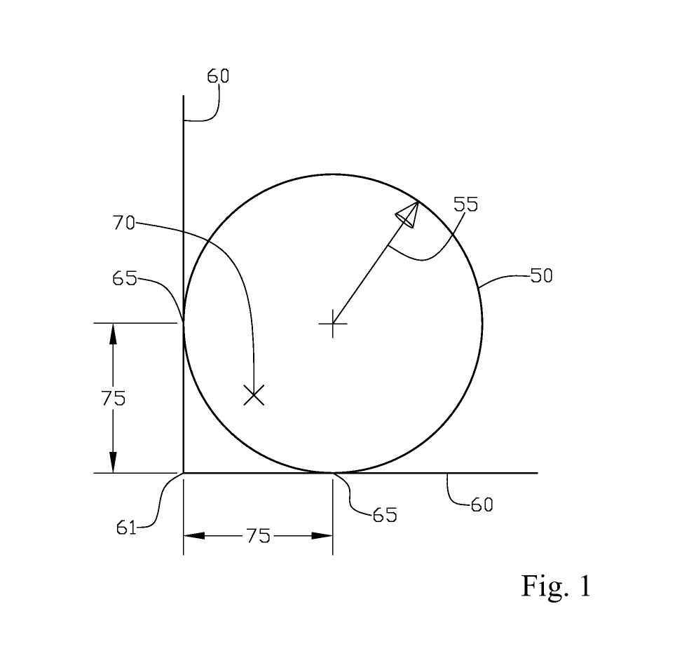

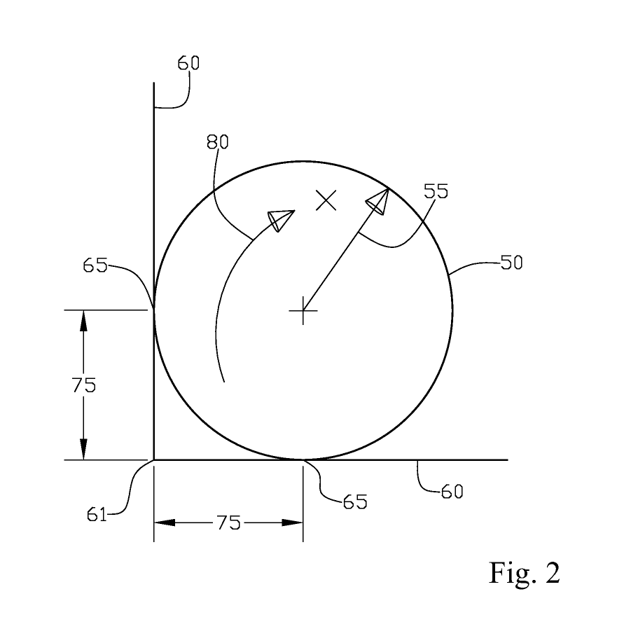

With initial reference to FIG. 1 shown is the forming ball 50 of a radius 55 oriented in a corner 61 as between two surfaces 60, noting that even with omni-directional rotation 70-80 of the forming ball 50, the contact points 65 of the ball 50 on the surfaces 60 remain consistent upon the two surfaces 60 for the forming ball 50 with the radius 55 of a specific size. Next, FIG. 2 shows the forming ball 50 of the radius 55 oriented in a corner 61 as between two surfaces 60, noting that even with omni-directional rotation 70-80 of the forming ball 55, the contact points 65 of the ball 50 on the surfaces 60 remain consistent upon the two surfaces 60 for the forming ball 50 with the radius 55 of size. Referring back to FIG. 1, the forming ball 50 having a radius 55 oriented in a corner 61 between two generally perpendicular surfaces 60 while contacting 65 both surfaces 60 establishes contact points 65 that are equally distant 75 from the corner 61 of the surfaces 60 and thus equal to the radius 55 of the forming ball 50 that establishes the contact points 65. A point 70 deemed “X” on the forming ball 50 demonstrates rotation of the forming ball 50 when going from FIG. 1 to FIG. 2, wherein the point 80 again deemed “X” shows the nature of rotational movement of the forming ball 50, wherein the contact points 65 remain the same. Thus, while the forming ball 50 remains in contact 65 with the surfaces 60 as described above, the contact points 65 remain consistent despite the movement of point 70 deemed “X” to point 80 also deemed “X” to a different location as shown in FIG. 2.

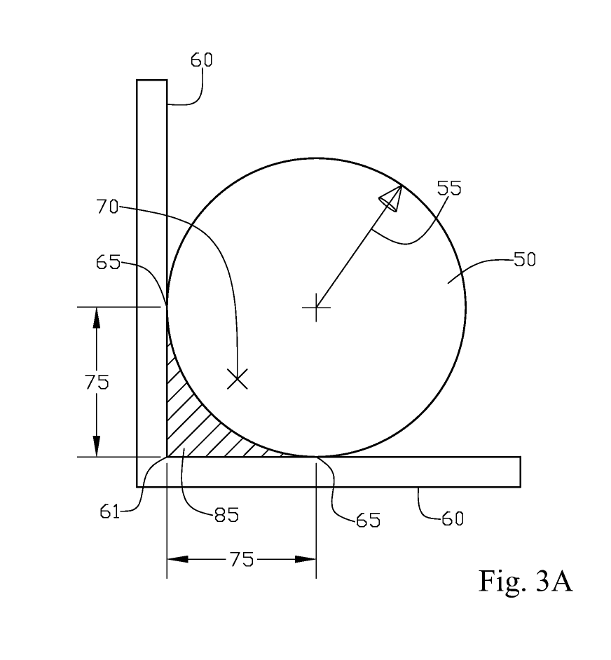

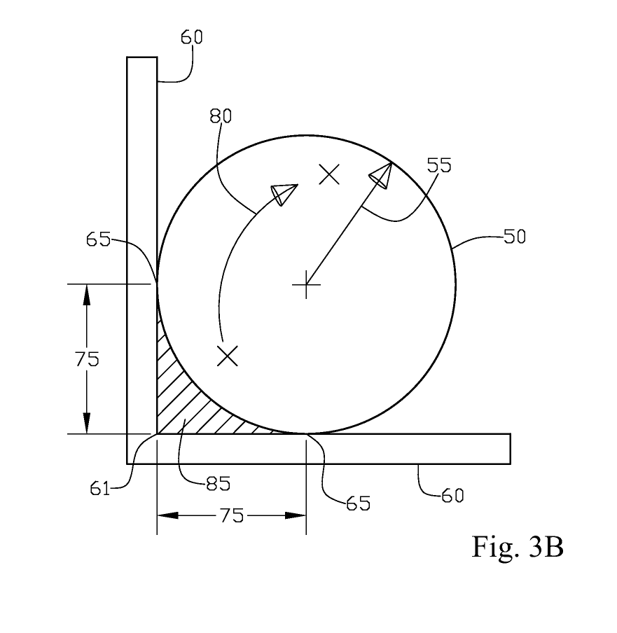

Further, FIG. 3A shows the forming ball 50 of a the radius 55 “R” oriented in a corner 61 between two surfaces 60, noting that even with omni-directional rotation 70-80 of the forming ball 50, the contact points 65 of the ball 50 on the surfaces 60 remain consistent upon the two surfaces 60 for the forming ball 50 with the larger specific radius 55, wherein under the forming ball 50 and in-between the two surfaces 60 the caulk fillet 85 in cross section is formed. Continuing, FIG. 3B shows a forming ball 50 of a the radius 55 “R” oriented in a corner 61 between two surfaces 60, noting that even with omni-directional rotation 70-80 of the forming ball 50, the contact points 65 of the ball 50 on the surfaces 60 remain consistent upon the two surfaces 60 for the forming ball 50 with the larger specific radius 55, wherein under the forming ball 50 and in-between the two surfaces 60 the caulk fillet 85 in cross section is formed.

Looking back to FIG. 3A the forming ball 50 with the radius 55 is oriented adjacent to the corner 61 having the contact points 65 that are the distance 75 from the corner 61 on the surfaces 60 equal to the radius 55 of the forming ball 50 as described above. The forming ball 50 is oriented as described inherently forms a space beneath the forming ball 50 that is bounded by the perpendicular surfaces 60 and corner 61, wherein the caulking material 85 is shown, that again the contact points 65 remain consistent despite the rotation of the forming ball 50 shown by depicted by point 70 deemed “X” moving to point 80 deemed “X” as shown in FIG. 3B.

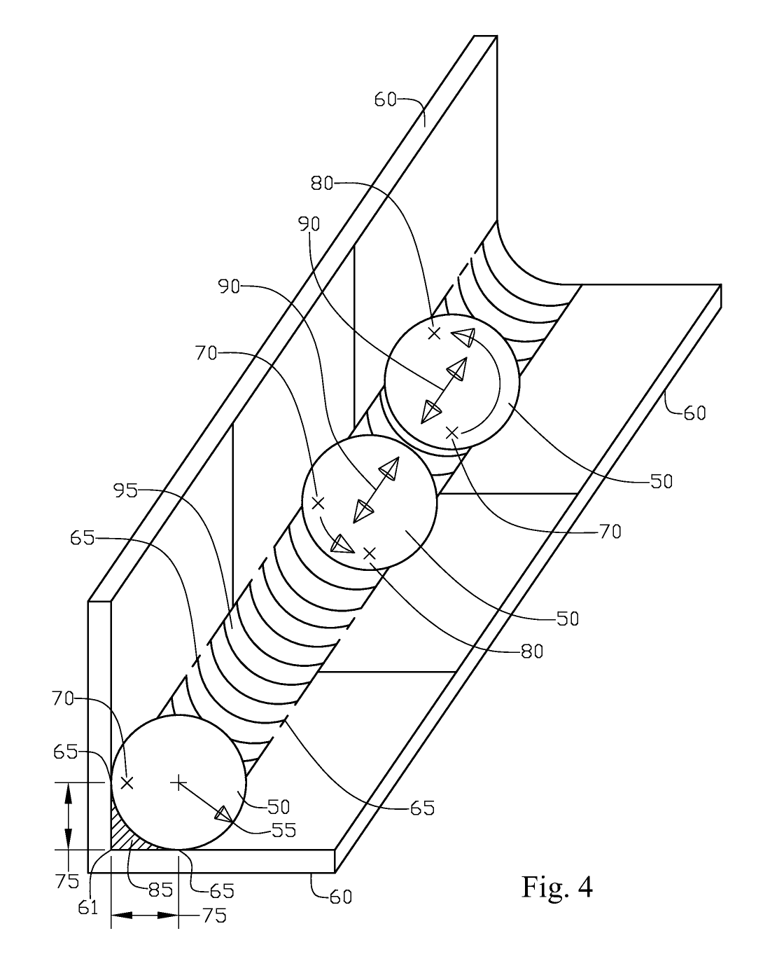

Next, FIG. 4 shows a perspective view of FIGS. 3A and 3B with the forming ball 60 of radius 55 “R” oriented in the corner 61 as between the two surfaces 60, as the forming ball 50 moves 90 lengthwise parallel to the corner 61 and the two surfaces 60 while the forming ball 50 is lengthwise slidably 90 contacting both surfaces 60, the caulk fillet 85 is shaped and formed 95 under the forming ball 50 and in-between the two surfaces 60, wherein the space beneath the forming ball 50 between the slidable contact lines 65 on the two surfaces 60 remains consistent. Further, in FIG. 4, the forming ball 50 with the radius 55, is oriented in the corner 61 and having the contact points 65 on the surfaces 60 that are the equal distance 75 from the corner 61 of the surfaces 60, which are equal to the radius 55 of the forming ball 50. Thus in the perspective view in FIG. 4, the two lines of contact points 75 are thus established on the surfaces 60 and a 3-dimensional space or volume is established under the forming ball 50 and between the contact lines 75 as the ball moves 90 parallel to while slidably touching at the contact points 65 on both surfaces 60, depicted by the same forming ball 50 moving 90 lengthwise from a position to another position along the contact 65 lines. As shown in FIG. 4, the contact 65 lines and the space established below the forming ball 50 between the contact lines 65 as described above remain consistent despite this movement 90 along the contact lines 65, and further including the despite the rotation of point 70 deemed “X” to point 80 deemed “X” shown on the forming ball 50, noting that slidable movement 90 results in the caulking material 85 creating a smooth formed fillet 95.

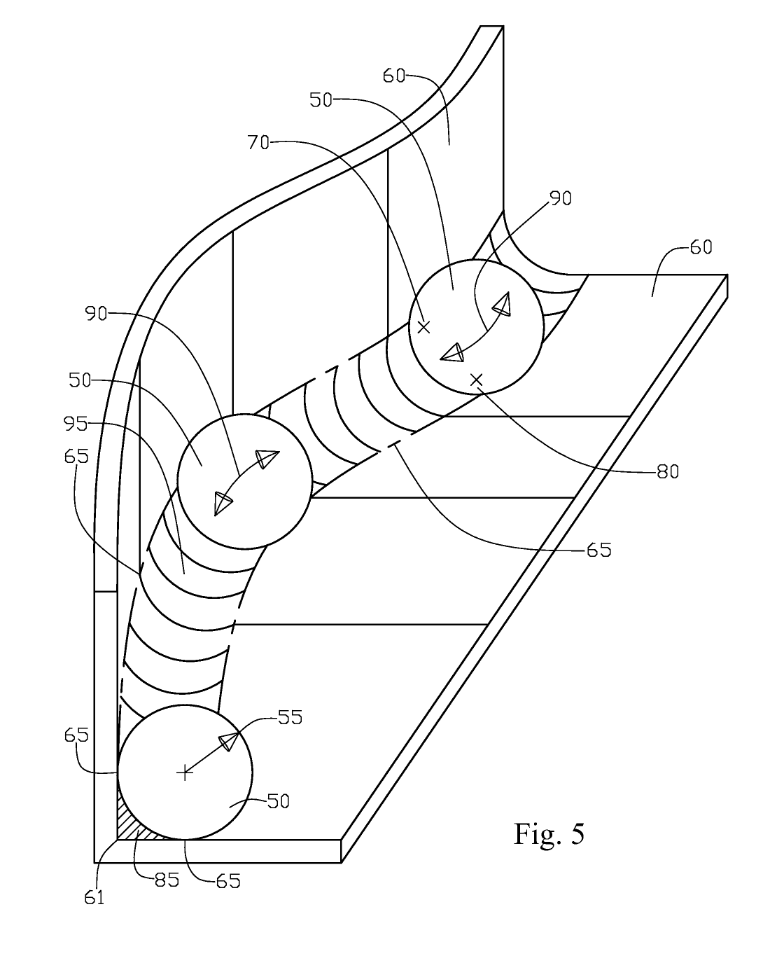

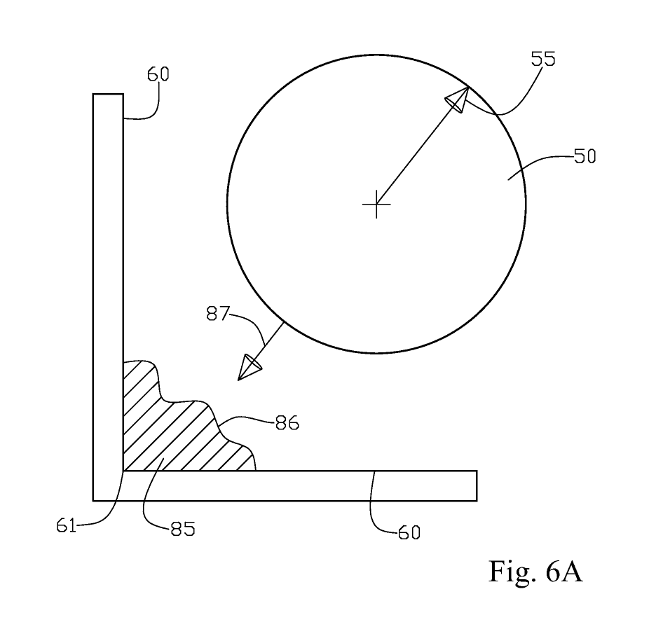

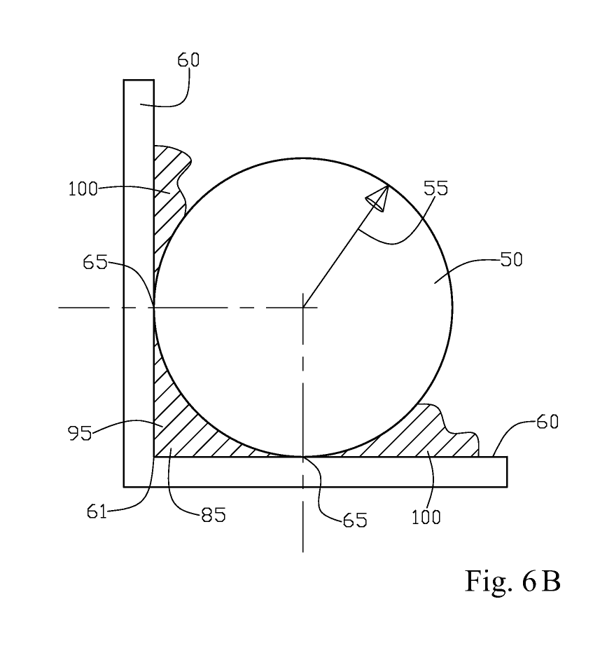

Further, FIG. 5 shows a perspective view of FIGS. 3A and 3B and further FIG. 4 with the modification of the lengthwise corner 61 being curved or non-linear, with the forming ball 50 of radius 55 “R” oriented in the corner 61 as between the two surfaces 60, as the forming ball 50 moves 90 lengthwise parallel to the corner 61 and the two surfaces 60 while the forming ball 50 is slidably 90 contacting 65 both surfaces 60, the caulk fillet 85 is shaped and formed 95 under the forming ball 50 and in-between the two surfaces 60, wherein the space beneath the forming ball 50 between the slidable 90 contact lines 65 on the two surfaces 60 remains consistent. Next, FIG. 6A shows the forming ball 50 prior to contacting 87 the two surfaces 60 in a slidable manner 90, being at the point where the caulk bead 86 has just been applied to the corner 61 between the two surfaces 60, wherein it is shown in cross section the caulk bead is in a rough and uneven state 86 having a free surface that is having multiple undulations. Continuing in FIG. 5, shows much the same as FIG. 4, with the exception of the corner 61 follows a non-linear path wherein all the previously described attributes still apply of the contact points 65 remaining constant even while the forming ball 50 is having slidable movement 90 and/or rotational movement in point 70 deemed “X” moving toward point 80 deemed “X”.

Continuing, FIG. 6B shows the forming ball 50 contacting the two surfaces 60 being similar to FIGS. 3A, 3B, 4, and 5, however, showing the addition of the excess caulk material 100 being extruded or pushed from the smooth formed caulk fillet 95 area underneath the forming ball 50 to being outside of the contact points 65 adjacent to the surface 60 where the excess caulk material 100 is deposited while sliding 90 the forming ball 50 lengthwise along the two surfaces 60. Wherein, the caulk fillet 95 underneath the forming ball 50 is forced into the corner 61 as between the two surfaces 60 to form a better and stronger seal between the two surfaces 60. Next, in looking back at FIG. 6A, the forming ball 50 of radius 55 “R” is removed from being oriented between the two surfaces 60 that establish the corner 61, wherein the surface 60 and the corner 61 partially contain the raw caulk bead 86 prior to the forming ball 50 coming or moving 87 into contact with the contact points 65 of the surfaces 60, wherein the forming ball 50 comes into contact with the raw caulk bead 86 as is shown in FIG. 6B. Thus in FIG. 6B, the caulking material 85 is formed into the smooth formed fillet 95 forcing the caulking material 85 into the corner 61, via coming into contact with the forming ball 50, wherein an excess of caulking material 100 will ooze around the forming ball 50, with the excess material 100 remaining as against the surfaces 60.

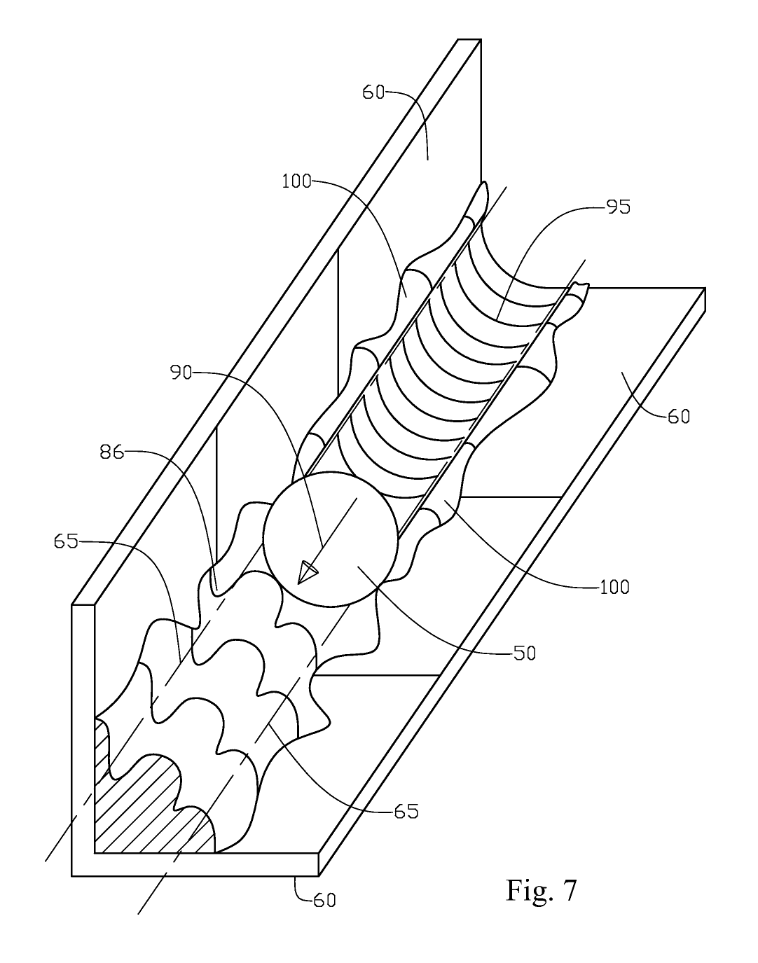

Moving onward, FIG. 7 shows a perspective view of FIG. 6B that better shows the before and after configuration of the caulk bead 85 as the forming ball 50 slidably 90 contacts 65 the two surfaces 60 with the forming ball 50 contacting 65 the two surfaces 60 being similar to FIGS. 3A, 3B, 4, and 5. However, showing the addition of the excess caulk material 100 being extruded or pushed from the smooth formed caulk fillet 95 area underneath the forming ball 50 to being outside of the contact points 65 adjacent to the surface 60 where the excess caulk material 100 is deposited while sliding 90 the forming ball 50 lengthwise along the two surfaces 60, wherein the caulk fillet 95 underneath the forming ball 50 is forced into the corner 61 as between the two surfaces 60 to form a better and stronger seal between the two surfaces 60. Further, FIG. 7 shows a perspective view of FIG. 6B, wherein the forming ball 50 comes into contact with the raw caulk bead 86 via slidable movement 90. Thus in FIG. 7, the caulking material 85 is formed into the smooth formed fillet 95 forcing the caulking material 85 into the corner 61, via coming into contact with the forming ball 50, wherein an excess of caulking material 100 will ooze around the forming ball 50, with the excess material 100 remaining as against the surfaces 60 during slidable movement 90.

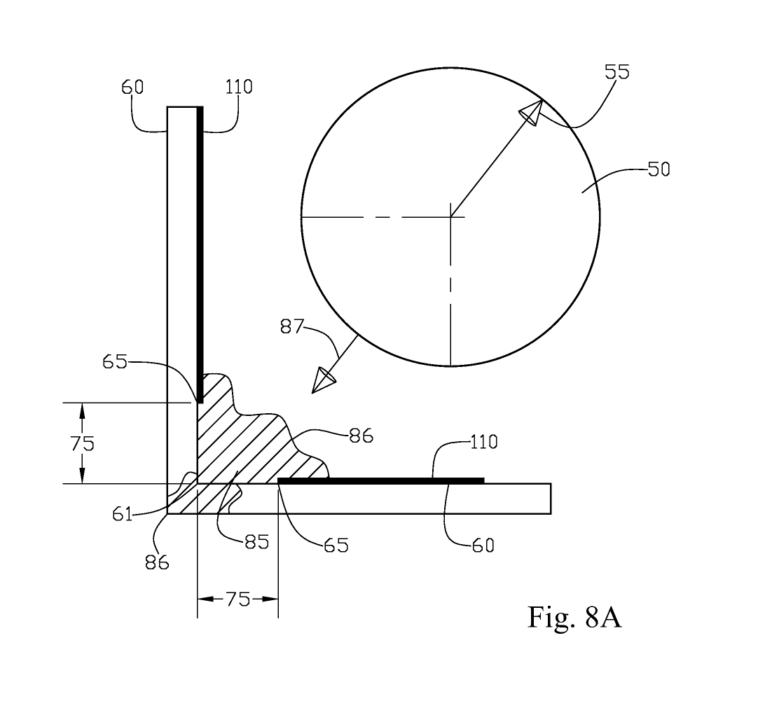

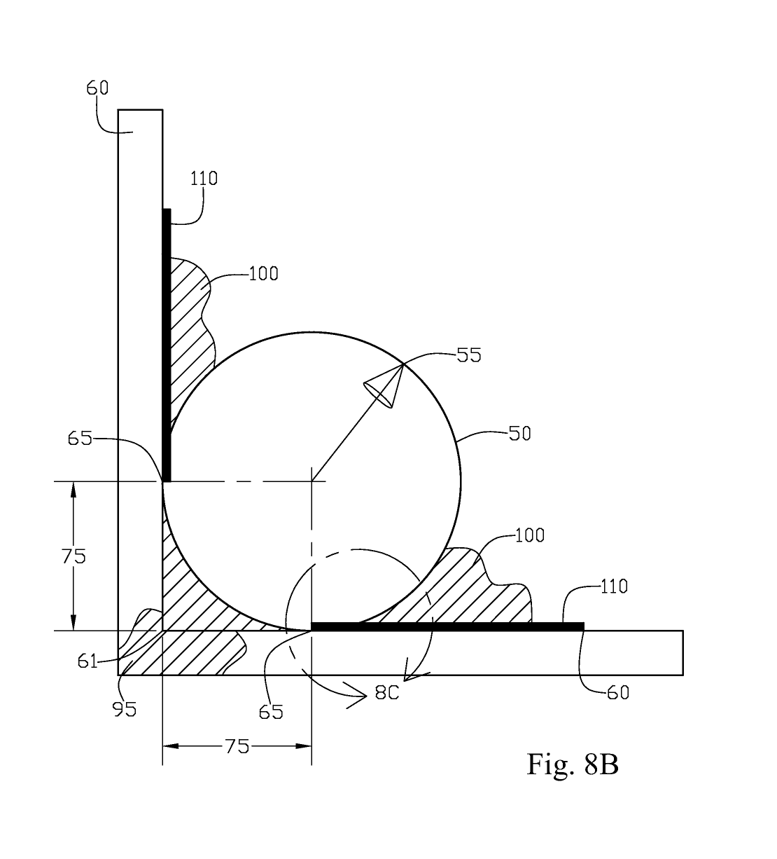

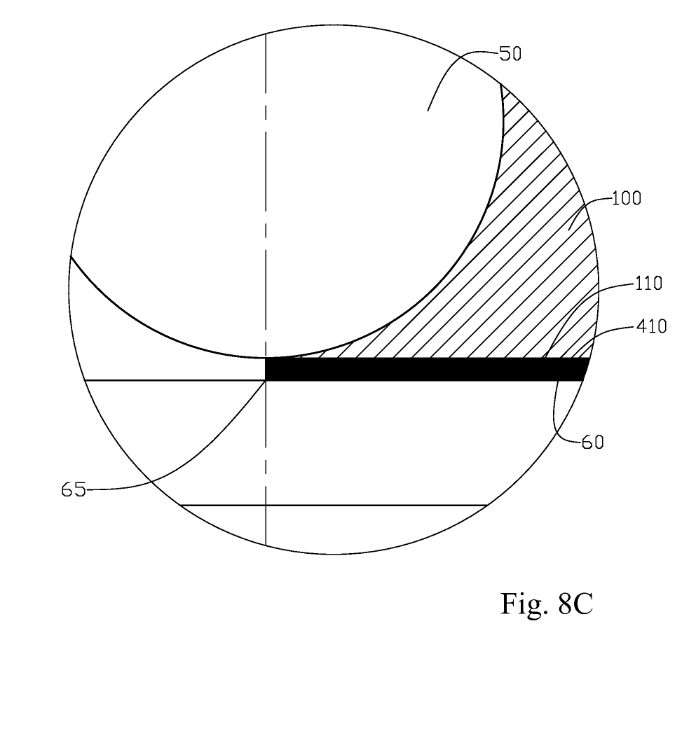

Next, FIG. 8A shows the forming ball 50 prior to contacting 87 the two surfaces 60 in a slidable manner, being at the point where the caulk bead 85 has just been applied to the corner 61 between the two surfaces 60, wherein it is shown in cross section the caulk bead is in a rough and uneven state 86 having a free surface that is having multiple undulations, note also the tape 110 in cross section is shown being applied lengthwise at a distance 75 from the corner 61 on each of the two surfaces 60. Looking back at FIG. 8A the forming ball 50 is positioned as in FIG. 6A, except that in FIG. 8A on the surfaces 60 the tape strip 110 is shown in cross section with the tape strip 110 positioned at the distance 75 away from the corner 61, wherein the raw caulk bead 86 is in contact with both the surfaces 60 from the corner 61 outward and overlapping the tape strip 110. Thus as is shown in FIG. 8A, prior to the forming ball 50 coming or moving 87 into contact with the contact points 65 of the surfaces 60, wherein the forming ball 50 comes into contact with the raw caulk bead 86 as is shown in FIG. 8B.

Continuing, FIG. 8B shows the forming ball 50 contacting 65 the two surfaces 60 being similar to FIGS. 3A, 3B, 4, and 5, however, showing the addition of the excess caulk material 100 being extruded or pushed from the smooth formed caulk fillet 95 area underneath the forming ball 50 to being outside of the contact points 65 adjacent to the surface 60 where the excess caulk material 100 is deposited. This is while sliding 90 the forming ball 50 lengthwise along the two surfaces 60, wherein the caulk fillet 95 underneath the forming ball 50 is forced into the corner 61 as between the two surfaces 60 to form a better and stronger seal between the two surfaces 60. Note also in FIG. 8B, the tape 110 in cross section is shown being applied lengthwise at a distance 75 from the corner 61on each of the two surfaces 60, also that the forming ball 50 contacts 65 the two surfaces 60 on the tape 110 that is disposed between the forming ball 50 and the two surfaces 60. Thus in FIG. 8B, the caulking material 85 is formed into the smooth formed fillet 95 forcing the caulking material 85 into the corner 61, via coming into contact with the forming ball 50, wherein an excess of caulking material 100 will ooze around the forming ball 50, with the excess material 100 remaining as against the surfaces 60, wherein the excess caulking material 100 is in contact with the tape strip 110, wherein an expanded view 8C is indicated in FIG. 8B.

Further, FIG. 8C is an expanded view from FIG. 8B of the cross section that denotes the tape 110 in cross section as being shown being applied 410 lengthwise at a distance 75 from the corner 61 on one of the two surfaces 60, also shown is the forming ball 50 contacting the tape 110 on the surface 60 that is disposed between the forming ball 50 and the surface 60. Further, FIG. 8C shows the preferred interface of the forming ball 50 contact point 65 as against the surface 60 laying upon the tape strip 110 with the excess caulking material 100 shown.

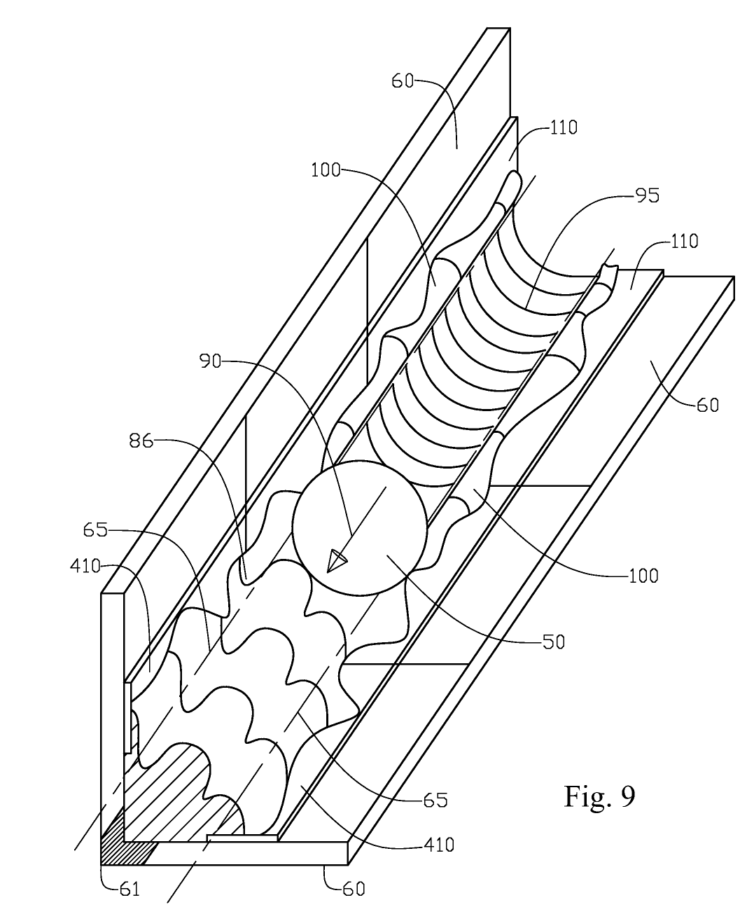

Yet further, FIG. 9 is similar to FIG. 7 with the addition of the tape 110 shown in perspective view as applied 410 lengthwise at a distance 75 from the corner 61 on each of the two surfaces 60, also that the forming ball 50 contacts 65 the two surfaces 60 on the tape 110 that is disposed between the forming ball 50 and the two surfaces 60. Yet, further in FIG. 9, the before 86 and after 95 configuration of the caulk bead 85 is shown as the forming ball 50 slidably 90 contacts 65 the lengthwise tape 110 on the two surfaces 60, showing the excess caulk material 100 being extruded or pushed from the smooth formed caulk fillet 95 area underneath the forming ball 50 to being outside of the contact points 65 adjacent to the tape 110 on the surface 60 where the excess caulk material 100 is deposited on top of the tape 110 while sliding 90 the forming ball 50 lengthwise along the two surfaces 60, wherein the caulk fillet 95 underneath the forming ball 50 is forced into the corner 61 as between the two surfaces 60 to form a better and stronger seal between the two surfaces 60. Next in FIG. 9, being similar to FIG. 7, except for the addition of the tape strip 110 as previously discussed. Thus in FIG. 9 also being essentially a perspective view of FIG. 8B, FIG. 9 shows the forming ball 50 coming into contact with the raw caulk bead 86 via slidable movement 90, with the lengthwise positioning of the tape strip 110 shown on both surfaces 60. Thus in FIG. 9, the caulking material 85 is formed into the smooth formed fillet 95 forcing the caulking material 85 into the corner 61, via coming into contact with the forming ball 50, wherein an excess of caulking material 100 will ooze around the forming ball 50, with the excess material 100 remaining as against the tape strip 110 that is on the surfaces 60 during slidable movement 90.

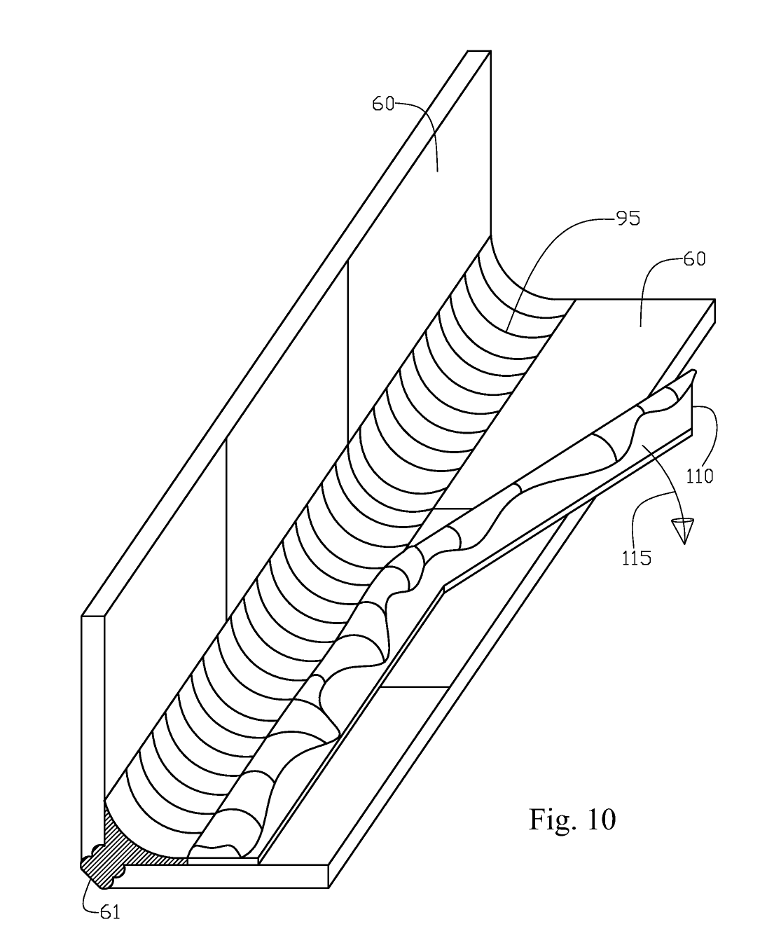

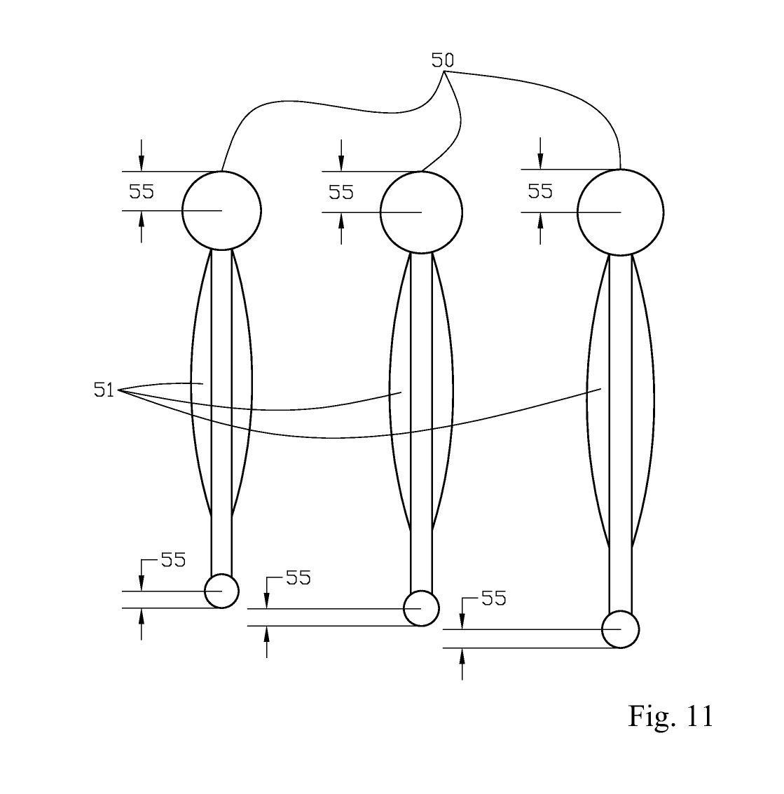

Moving onward, FIG. 10 shows the FIG. 9 view after the forming ball 50 has moved 90 lengthwise along the surfaces 60 on the tape 110, wherein the excess caulk 100 is disposed upon the tape 110 that is on the surface 60, that when the tape 110 with the excess caulk material 100 is removed 115, what is left is an evenly formed, consistent fillet bead 95 of caulk material formed in the corner between the two surfaces 60. Continuing, FIG. 11 shows a set of the forming ball tools 50 of different radii 55 that include handles 51, with the forming ball 50 tools going from the small radius 55 to the large radius 55 in size. Moving ahead in FIG. 10, after the forming ball 50 completes slidable movement 90 lengthwise along the surface 60 upon the tape strip 110 leaving the smooth formed fillet 95, the final step is to remove 115 the tape strip 110 from the surface 60 as shown on each side of the corner 61, thus leaving the smooth formed fillet 95 with straight edges as against the surfaces 60 via removal 115 of the tape strip 110.

Continuing in FIG. 11, a grouping of the forming balls 50 is shown that can be utilized having different radii 55, further, handles 51 can also be added for user convenience, also on the opposing end of the handle 51 another size forming ball 50 with a different radius 55 is shown. The size of the radii 55 can preferably range from about 0.125 inches to 1.0 inches, wherein the handle and forming ball 50 assembly can be constructed of any material that is compatible with caulk material 85 or other suitable equivalent material that is compatible with a caulking material substitute.

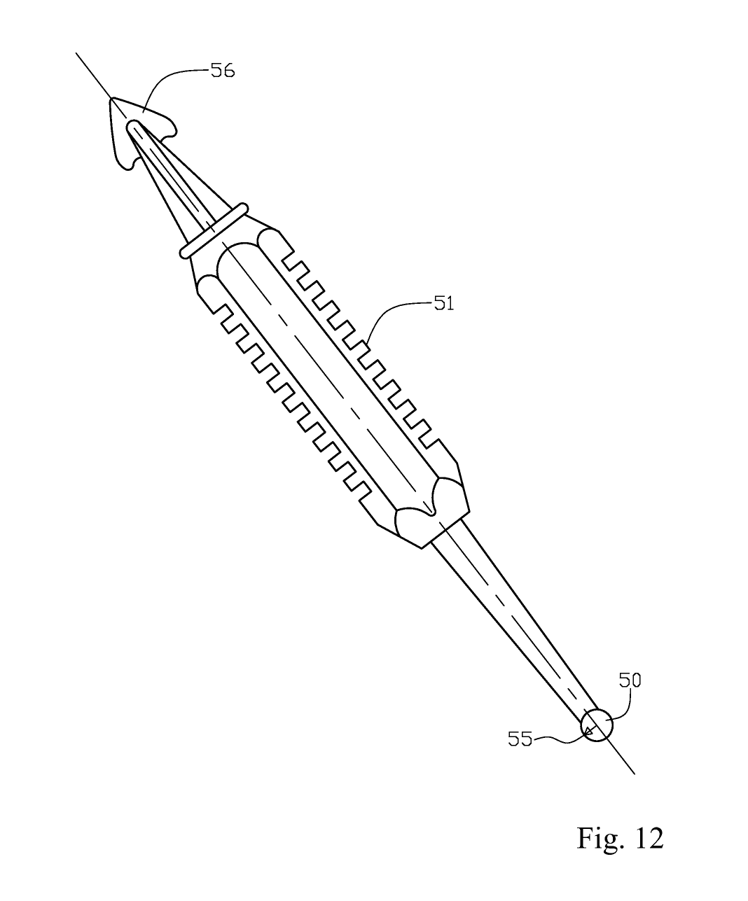

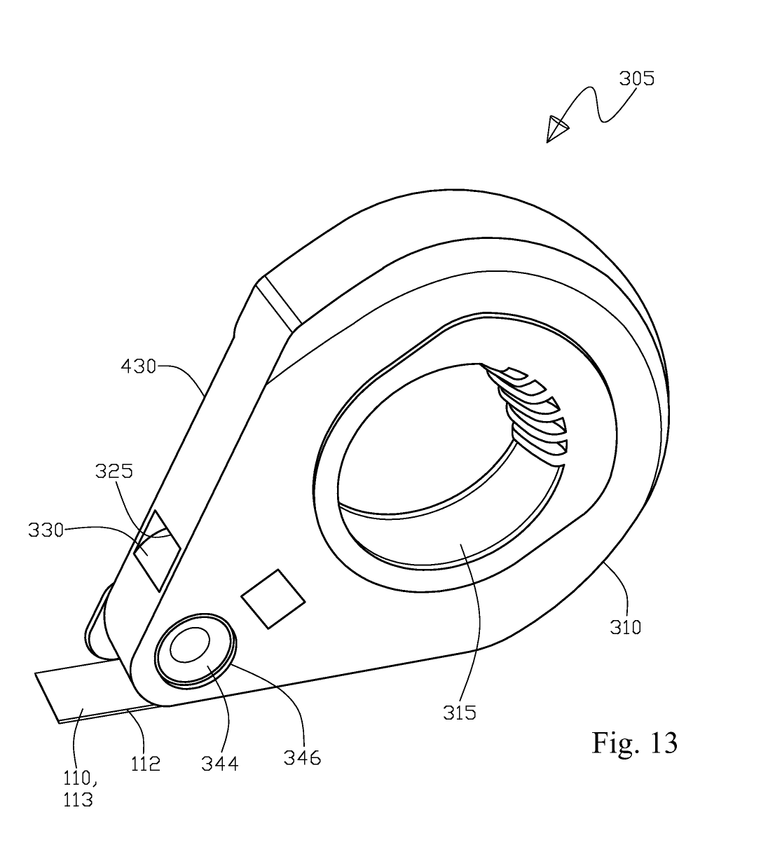

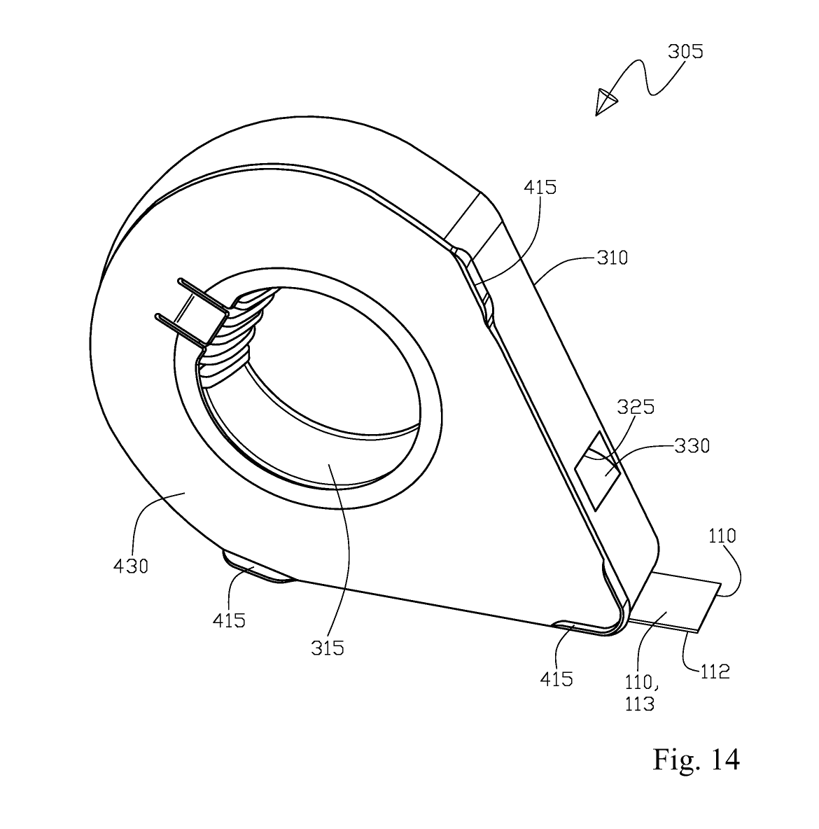

Next, FIG. 12 shows an elevation view of another embodiment of the forming ball 50 tool having a scrapper tip 56 for removing old caulk, the handle 51 and a forming ball on the opposing end. Continuing, FIG. 13 shows a perspective view of the of the tape dispenser apparatus 305 showing the first housing portion 310 with hub 315, the second housing portion 430, the tape aperture 325, the tape channel 330, the adhesive side 112 of the tape strip 110, the non adhesive tape side 113, and the cutting blade actuator extension 344, with the cutting blade 340 in the retracted state 355. Further, FIG. 14 shows an opposing view perspective view from FIG. 13 of the of the tape dispenser apparatus 305 showing the first housing portion 310 with hub 315, the second housing portion 430, the tape aperture 325, the tape channel 330, the adhesive side 112 of the tape strip 110, the non adhesive 113 tape side, with the cutting blade 340 in the retracted state 355.

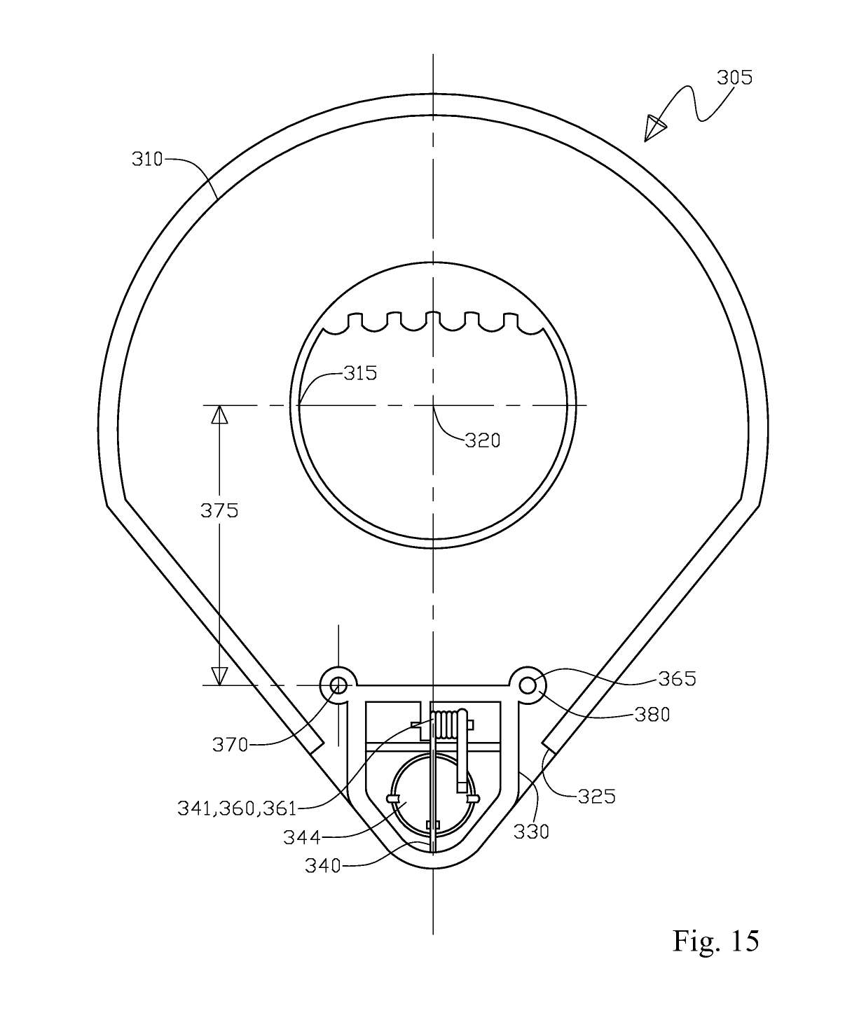

Continuing, FIG. 15 shows a view of the tape dispenser apparatus 305 with the second housing portion 430 removed and tape roll 105 removed, thus exposing the first housing portion 310 and hub 315, the first rotational axis 320, the parallel relationship 375 between the first rotational axis 320 and the rotational axis 370, the roller 365. Further shown in FIG. 15 is the positioning of the roller 365 to be proximate to the non-adhesive side 113 of the tape 105, plus the cutter 340, the extension of the cutter 344, the means 360 for urging the cutter 340 into the retracted operational state 355, the spring 361 for the means 360 for urging the cutter 340 into the retracted operational state 355, the tape aperture 325, and the tape channel 330.

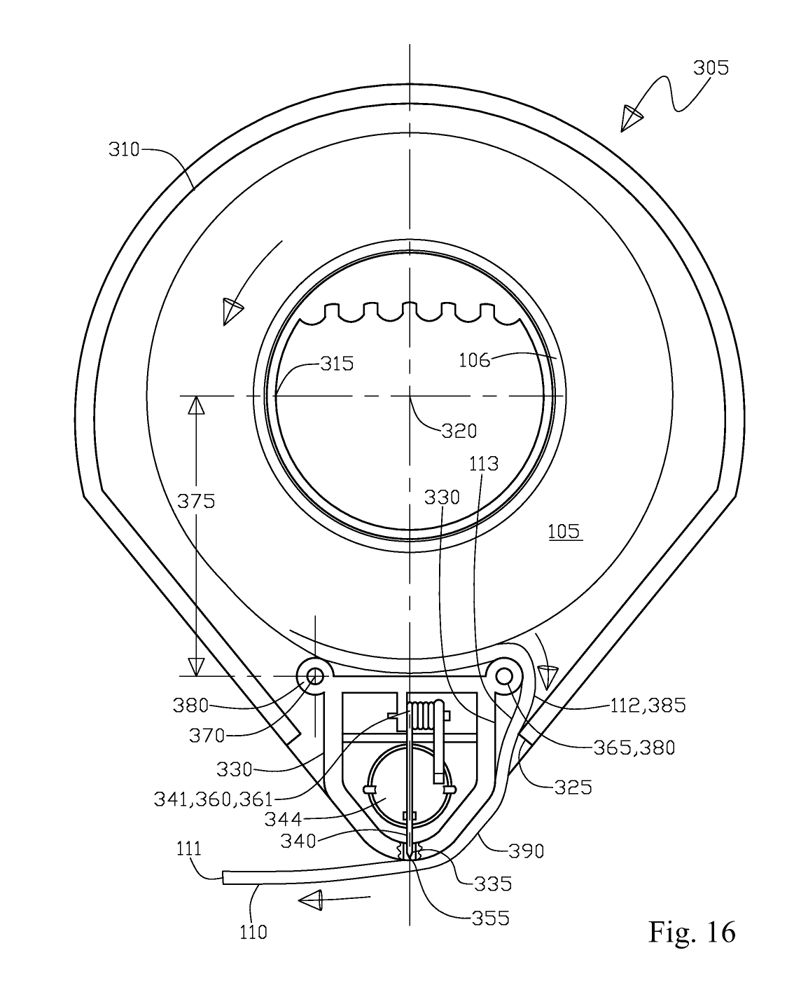

Next, FIG. 16 shows a view of the tape dispenser apparatus 305 with the second housing portion 430 removed thus exposing the first housing portion 310 and hub 315, with the tape roll 105 in-place, with the tape strip 110 feed around the roller 365 and into the tape aperture 325 and tape channel 330 with the correct positioning of the tape adhesive side 112 and non-adhesive side 113. Also shown in FIG. 16 is the first rotational axis 320, the parallel relationship 375 between the first rotational axis 320 and the rotational axis 370, the roller 365, the positioning of the roller 365 to be proximate to the non-adhesive side 113 of the tape 110, plus the cutter 340 in the retracted operational state 355, the cutter aperture 335, the extension of the cutter 344, the means 360 for urging the cutter 340 into the retracted operational state 355, the spring 361 for the means 360 for urging the cutter 340 into the retracted operational state 355, the tape aperture 325, the tape channel 330, and the edge of the tape 111.

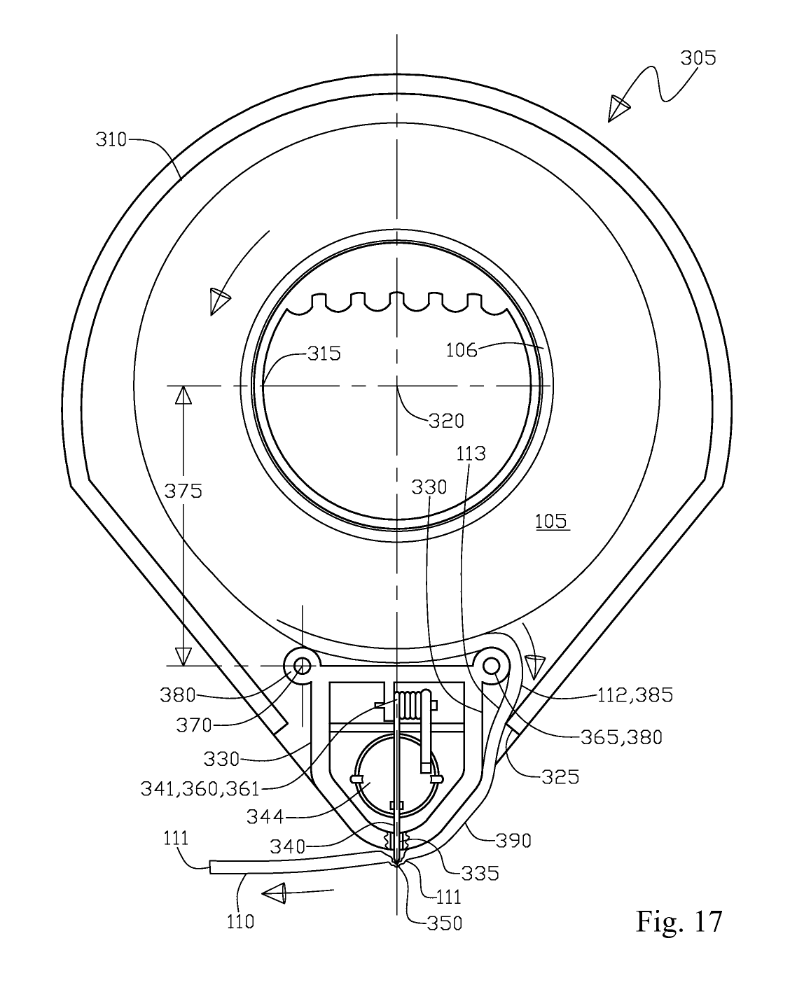

Further, FIG. 17 shows a view of the tape dispenser apparatus 305 with the second housing portion 430 removed thus exposing the first housing portion 310 and hub 315, with the tape roll 105 in-place, with the tape strip 110 feed around the roller 365 and into the tape aperture 325 and tape channel 330 with the correct positioning of the tape adhesive side 112 and non-adhesive side 113. Also shown in FIG. 17 is the first rotational axis 320, the parallel relationship 375 between the first rotational axis 320 and the rotational axis 370, the roller 365, the positioning of the roller 365 to be proximate to the non-adhesive side 113 of the tape 110, plus the cutter 340 in the cutting operational state 350, the cutter aperture 335, the extension of the cutter 344, the means 360 for urging the cutter 340 into the retracted operational state 355, the spring 361 for the means 360 for urging the cutter 340 into the retracted operational state 355, the tape aperture 325, the tape channel 330, and the edge of the tape 111.

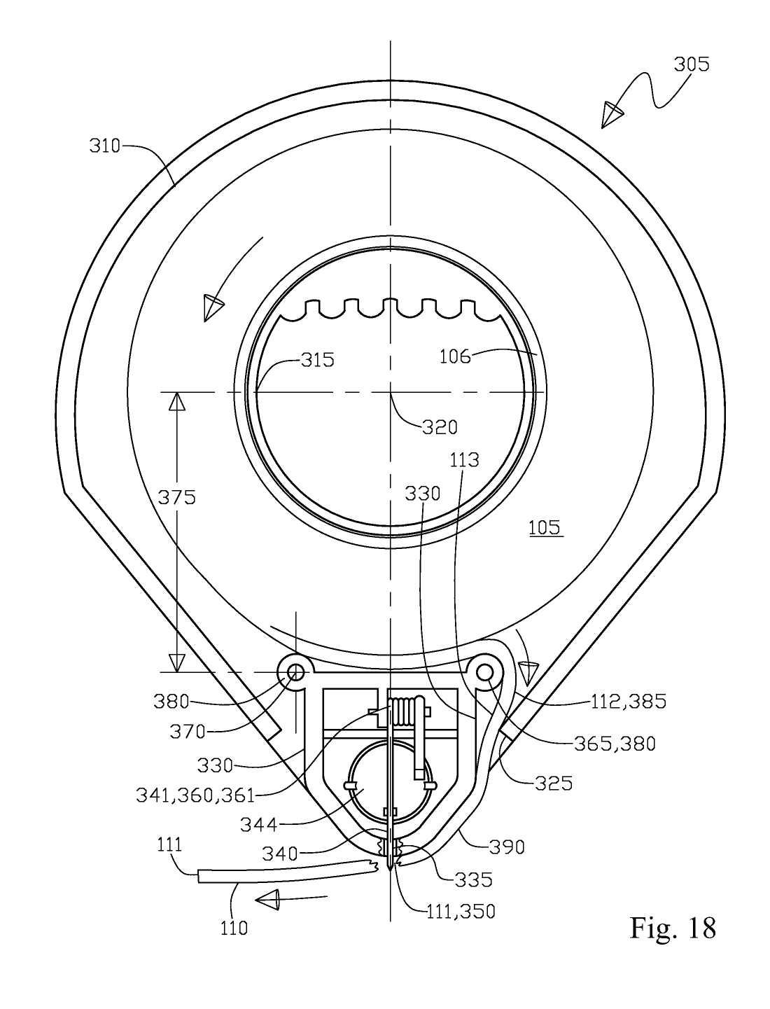

Continuing, FIG. 18 shows a view of the tape dispenser apparatus 305 with the second housing portion 430 removed thus exposing the first housing portion 310 and 315 hub, with the tape roll 105 in-place, with the tape strip 110 feed around the roller 365 and into the tape aperture 325 and tape channel 330 with the correct positioning of the tape adhesive side 112 and non-adhesive side 113. Also shown in FIG. 18 is the first rotational axis 320, the parallel relationship 375 between the first rotational axis 320 and the rotational axis 370, the roller 365, the positioning of the roller 365 to be proximate to the non-adhesive side 113 of the tape. Plus FIG. 18 shows the cutter 340 in the cutting operational state 350 that is completed, the cutter aperture 335, the extension of the cutter 344, the means 360 for urging the cutter 340 into the retracted operational state 355, the spring 361 for the means 360 for urging the cutter 340 into the retracted operational state 355, the tape aperture 325, the tape channel 330, and the edge of the tape 111.

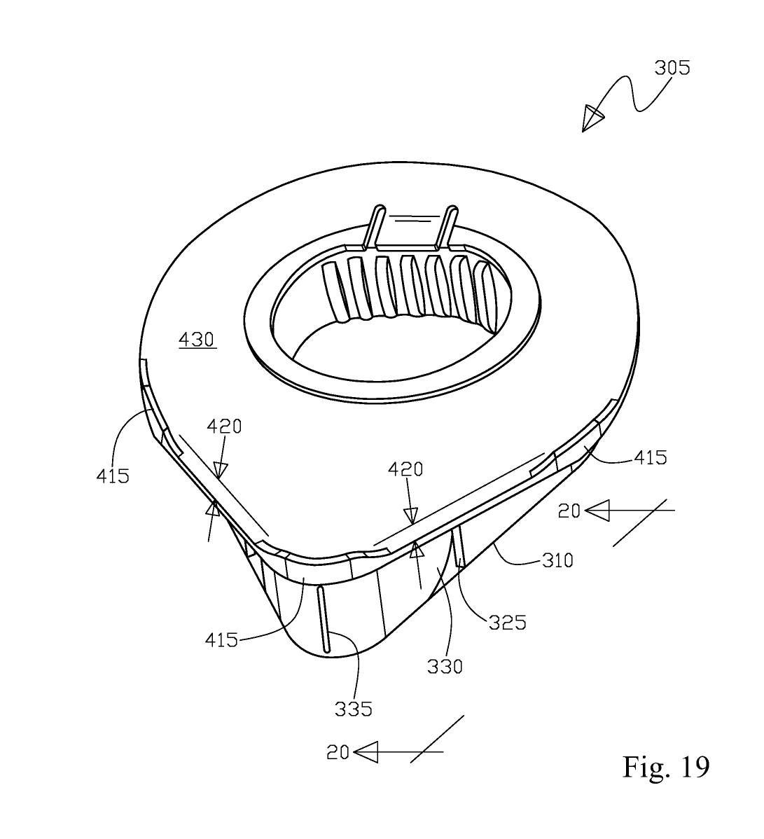

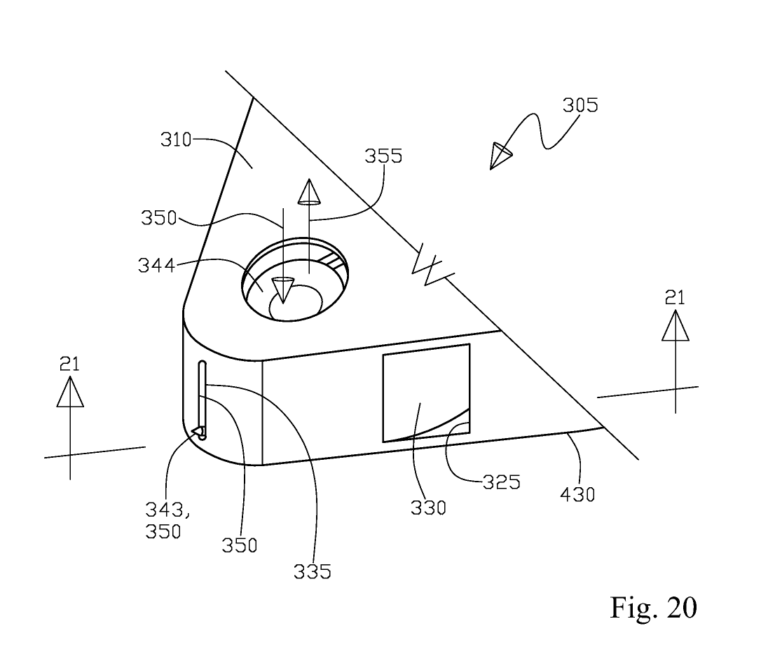

Moving onward, FIG. 19 shows a perspective view of the tape dispenser apparatus 305 from the second housing portion side 430 showing the tape aperture 325, the tape channel 330, the cutter aperture 335, the protrusions 415, and the gage height 420 of the protrusions 415. Next, FIG. 20 shows view 20-20 from FIG. 19 giving an expanded view of the cutter end in perspective showing the first housing portion side 310, the tape aperture 325, the tape channel 330, the cutter aperture 335, the cutter 340, the blunt edge 343 of the cutter 340, the extension 344 of the cutter 340, the cutter 340 extending through the aperture 335, the movement 350 and 355 of the cutter extension 344 that coincides with the cutter 340 for the cutting operational state 350 and the retracted operational state 355.

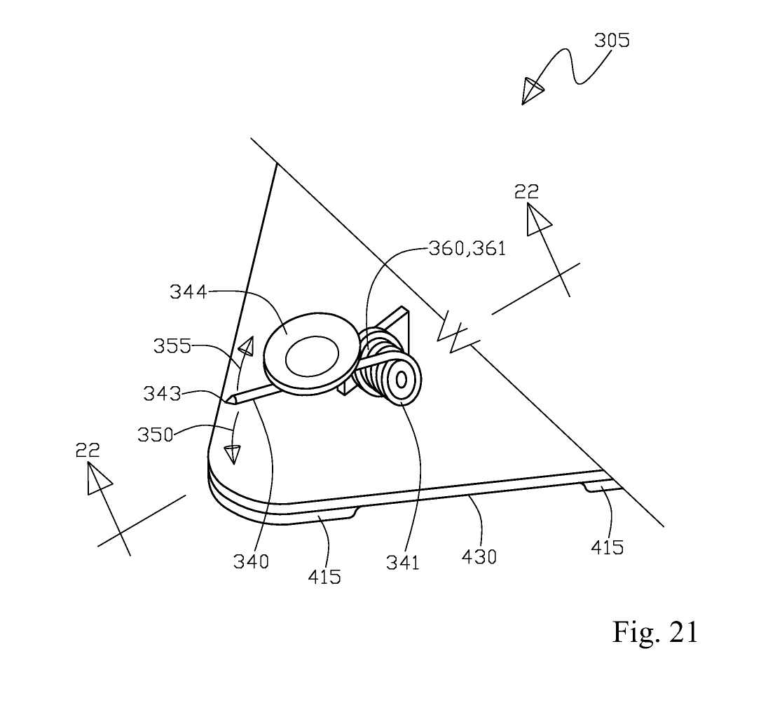

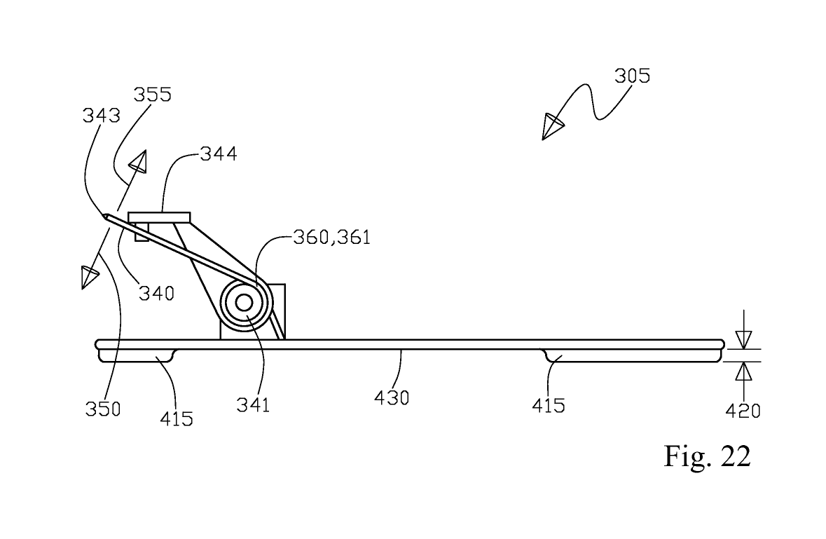

Further, FIG. 21 shows cross section cut 21-21 from FIG. 20 to show the internal detail of the cutter 340, with the second housing portion 430, the protrusions 415, plus the cutter 340 in either the retracted operational state 355 or the cutting operational state 350. Also shown in FIG. 21 is the extension 344 of the cutter 340, the blunt leading edge 343 of the cutter 340, the means 360 for urging the cutter 340 into the retracted operational state 355, and the spring 361 for the means 360 for urging the cutter 340 into the retracted operational state 355. Continuing, FIG. 22 shows view 22-22 from FIG. 21 to show the internal detail of the cutter 340, with the second housing portion 430, the protrusions 415, plus the cutter 340 in either the retracted operational state 355 or the cutting operational state 350. Further, FIG. 22 shows the extension 344 of the cutter 340, the blunt leading edge 343 of the cutter 340, the means 160 for urging the cutter into the retracted operational state 355, and the spring 361 for the means 360 for urging the cutter 340 into the retracted operational state 355.

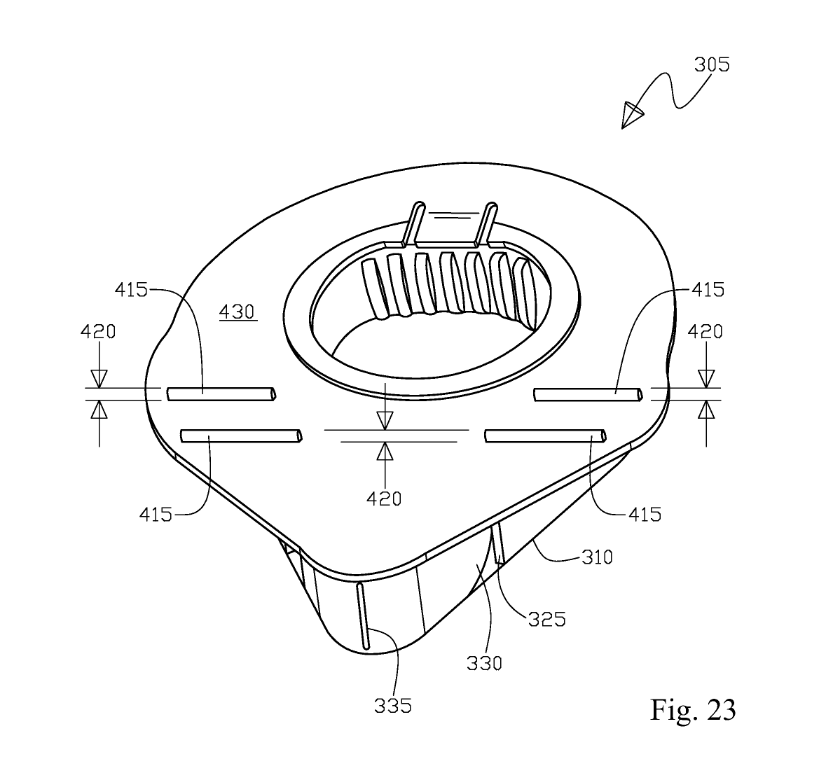

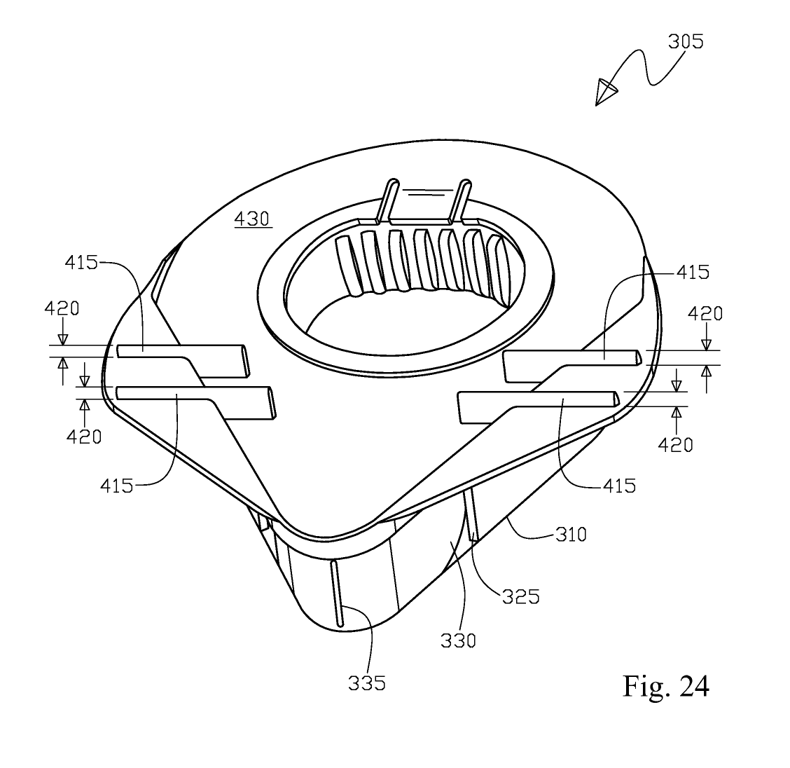

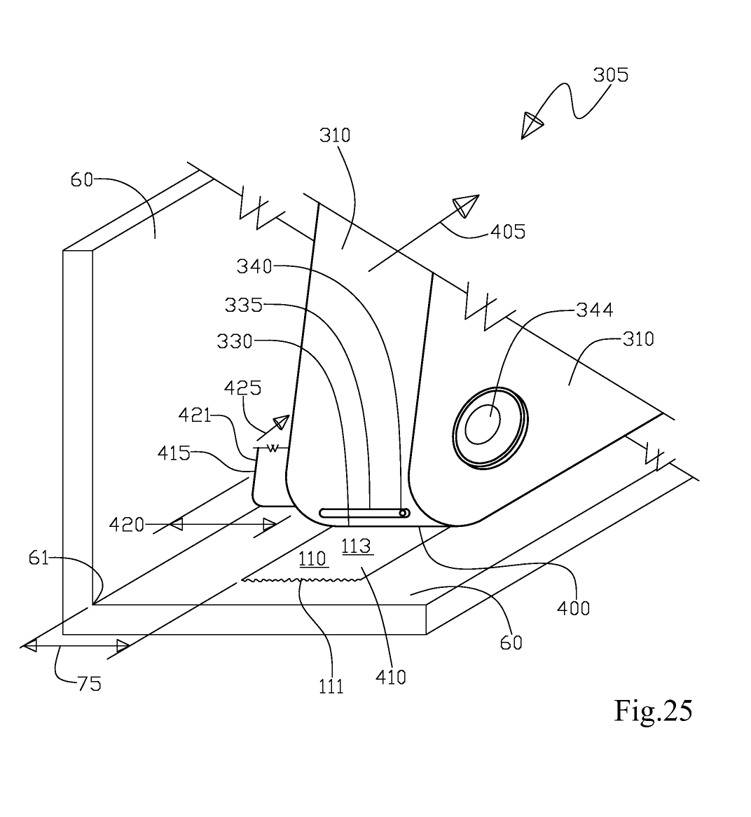

Continuing, FIG. 23 shows a perspective view of the tape dispenser apparatus 305 from the second housing portion side 430 showing the tape aperture 325, the tape channel 330, the cutter aperture 335, the protrusions 415, and the gage height 420 of the protrusions 415. Next, FIG. 24 shows a perspective view of the tape dispenser apparatus 305 from the second housing portion side 430 showing the tape aperture 325, the tape channel 330, the cutter aperture 335, the protrusions 415, and the gage height 420 of the protrusions 415. Further, FIG. 25 shows a use application perspective view wherein all protrusion embodiments 415 use the protrusions 415 as a gauge 420 to set the distance 420 that the applied tape 110 lengthwise positions itself from the corner 61 of the two surfaces 60.

Referencing FIGS. 13 through 24, for tape dispenser apparatus 305 which utilizes a roll of tape 110 with adhesive 112 on one side of the tape 105 for applying a strip of tape 110 from the roll of tape 105 to a surface 60 that is adjacent to another surface 60 that is perpendicularly oriented to one another at the corner 61, see in particular FIGS. 8A, 8B, and 25. The tape dispenser apparatus 305 includes a first housing portion 310 including a hub 315 for rotatably supporting the roll of tape 105, wherein the tape aperture 106 rotates about a first rotational axis 320. The first housing portion 310 also includes a tape aperture 325 feeding into a tape channel 330 that acts as a guide for the strip of tape 110, see FIGS. 13 through 19 and 25, further the first housing portion 310 includes a cutter aperture 335 disposed within the channel 330, see FIGS. 16 through 20, and 25.

Further included in tape dispenser apparatus 305 is a cutter 340 pivotally attached 341 to the first housing portion 310, wherein the cutter 340 extends therethrough the cutter aperture 335 in an extended cutting state 350 and the cutter 340 retracts from the cutter aperture 335 being disposed within the first housing portion 310 in a retracted state 355, wherein the cutter can be selectively placed via the extension 344 in the cutting state 350, see FIGS. 15 through 18 and 20 through 22. In addition, a means 360 for urging the cutter 340 into the retracted state 355 is included as a safety feature, see FIGS. 15 through 18, 21, and 22. Also, included is a roller 365 that is attached to the first housing portion 310, wherein the roller 365 is cylindrically positioned about a roller axis 370 that is positioned parallel 375 to the first rotational axis 320 and further the roller 365 is positioned such that it is proximate 380 to a non-adhesive side 113 of the tape, see FIGS. 15 through 18. Wherein operationally the roller 365 routes 385 the strip of tape 110 off of the roll of tape 105 around the cutter 340 to feed the strip of tape 110 into the tape aperture 325 and tape channel 330, see FIGS. 15 through 18, wherein operationally the tape channel 330 is manually positioned adjacent to the surface 60 and the first housing portion 310 manually pulled 405 in a lengthwise manner to lay the strip of tape 110 upon the surface 60, see FIG. 25, wherein the strip of tape 110 is selectively cut by the cutter 340, see FIGS. 16 through 18. The materials of construction for the first housing portion are preferably a molded plastic or any suitable equivalent for use with caulking 85 or similar materials. The cutter 340 is preferably made of stainless steel or any other corrosion resistant rigid material with properties like that of stainless steel.

For the means 360 for urging the cutter 340 into the retracted operational state 355, it is preferably a spring 361, as best shown in FIGS. 15 through 18 and 21 through 22. Also, on the cutter 340 it is preferably in the form of a wire with a leading edge 343, wherein leading edge 343 is blunt for user safety, wherein the leading edge 343 assists in cutting the tape 110 that is somewhat tensioned lengthwise in the face of having a non-sharp leading edge 343, such that it would be difficult for the user to cut themselves with the cutter 340. The wire is about 0.034 inches in diameter, as shown in FIGS. 15 through 18 and 21 through 22. To better facilitate the cutter 340 to be manually selectively placed in the extended cutting operational state 350, an optional extension aperture 346 is added to facilitate an added extension 344 that projects therethrough the extension aperture 346 disposed therethrough the first housing portion 310 to further enable the cutter 340 to be manually selectively placed in the cutting state 350, see FIG. 13.

Further, on tape dispenser apparatus 305, an optional second housing portion 430 can be added that is removably engaged to the first housing portion 310 such that the roller 365, the cutter 340 in the retracted state 355, and the means 360 for urging are completely enclosed being isolated from a user's hands for safety, see FIGS. 13 and 14. The materials of construction for the second housing portion 430 are the same as for the first housing portion 310. Alternatively, on tape dispenser apparatus 305, a protrusion 415 can be disposed upon the second housing portion 430 positioned opposite of the hub 315, see FIGS. 14, 19, and 22 through 24 wherein the protrusion is operationally in slidable contact 425 with the surface 60 that the tape 105 does not lay the strip of tape 110 on, with the protrusion 415 acting as a gauge 420 to set a distance of the tape strip 110 from the non-tape strip surface 60 or corner 61, see FIG. 25.

For user convenience, the tape dispenser apparatus 305 can be provided as a kit, where the tape dispenser apparatus 305 would be provided as previously described with the addition of the forming ball 50. Wherein the forming ball 50 would have a radius 55 sized in conjunction with the protrusion 415 height 420, wherein operationally the forming ball 50 shapes a caulking material 85 into a smooth fillet 95 in-between the surfaces 60, see FIGS. 8A, 8B, 8C, 9, 10, and 25. Further on the forming ball 50 radius 55 the radius 55 is sized to be substantially equal to a height 420 of the protrusion 415 away from the first housing portion 310. In addition, the kit could include the roll of tape 105 and/or the caulking material 85. Further as another option, a plurality of forming balls 50 could be provided in the kit with different size radii 55 and with handles 51, see FIG. 11.

### Method of Use

Focusing primarily on FIGS. 1 through 11, and FIG. 25, the tape dispenser apparatus 305 can be used as a kit that includes a set of forming ball 50 tools with spherical heads inherently containing an assortment of different radii 55, wherein the forming balls 50 include handles 51 as shown in FIGS. 11 and 12. Further included in the kit is the tape dispenser apparatus 305 and the roll of adhesive tape 105 and/or caulking material 85 if desired.

Thus for the method of forming, smoothing, 95 and setting a bead of caulking material 85 between two surfaces 60 that form a corner 61 between one another, the following steps are disclosed. Firstly of providing the tape dispenser apparatus 305 as previously described. A next step of providing a forming ball 50, further to providing a roll of tape 105, and of providing caulking material 85. Subsequent to this the roll of tape 105 would by loaded into the tape dispenser apparatus 305 and also feeding the strip of tape 110 around the roller 365 to clear the around the cutter 340 further feeding 390 the strip of tape 110 out the tape aperture 325 and around the tape channel 330, such that the strip of tape 110 adhesive side 112 faces outward, as best shown in FIGS. 13 through 18 and 25.

Referring in particular to FIG. 25, a next step of positioning 421 the protrusion 415 against one of the surfaces 60 and positioning 400 the tape channel 330 adjacent to the other surface 60. Continuing to refer to FIG. 25, a next step of pulling 405 the tape dispenser apparatus 305 or via the first housing 310 in a direction lengthwise against the surfaces 60 such that the protrusion 415 slides 425 along one of the surfaces 60 and the tape strip 110 is applied to the other surface 60. Then a step of engaging the cutter 340 by manually placing the cutter 340 into the cutting state 350 via pushing the extension 344 and cutting the strip of tape 110. Next, repeating the steps of; positioning 421 the protrusion 415 against one of the surfaces 60 and positioning 400 the tape channel 330 adjacent to the other surface 60, also pulling 405 the tape dispenser apparatus 305 or via the first housing 310 in a direction lengthwise against the surfaces 60 such that the protrusion 415 slides 425 along one of the surfaces 60 and the tape strip 110 is applied or laid 410 to the other surface 60, and the step of engaging the cutter 340 by manually placing the cutter 340 into the cutting state 350 via pushing the extension 344 and cutting the strip of tape 110. Such that this step repetition process requires that the surfaces 60 are reversed, wherein the tape strip 110 is applied to the surface 60 is was not previously applied to by pulling 405 the tape dispenser apparatus 300 or 305 or first housing portion 310 lengthwise against the surfaces 60 in the opposite direction.

Continuing, a step of applying the caulking material 85 to the corner 61 to form a lengthwise bead of raw caulking material bead 86 that overlaps onto the tape strips 110, see FIGS. 3A through 10. Next a step of sliding 90 the forming ball 50 lengthwise adjacent to the corner 61 forming a smooth fillet 95 of caulking material 85, see FIG. 9. Next a step of removing 115 the tape strips 110 from both surfaces 60 leaving an even edged smooth filet 95 of caulking material 85, see FIG. 10.

### CONCLUSION

Accordingly, the present invention of a tape dispenser apparatus, kit, and method has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. A tape dispenser apparatus utilizing a roll of tape with adhesive on one side of the tape for applying a strip of tape from the roll of tape to a surface that is adjacent to another surface that is perpendicularly oriented, comprising:
(a) a first housing portion including a hub for rotatably supporting the roll of tape, wherein the tape rotates about a first rotational axis, said first housing portion also includes a tape aperture feeding into a tape channel that acts as a guide for the strip of tape, further said first housing portion includes a cutter aperture disposed within said channel;
(b) a cutter pivotally attached to said first housing portion, wherein said cutter extends therethrough said cutter aperture in a cutting state and said cutter retracts from said cutter aperture being disposed within said first housing portion in a retracted state, wherein said cutter can be selectively placed in said cutting state;
(c) a means for urging said cutter into said retracted state; and
(d) a roller that is attached to said first housing portion, wherein said roller is cylindrically positioned about a roller axis that is parallel to said first rotational axis and said roller is positioned such that it is proximate to a non-adhesive side of the tape, wherein operationally said roller routes the strip of tape off of the roll of tape around said cutter to feed the strip of tape into said tape aperture and tape channel, wherein operationally said tape channel is manually positioned adjacent to the surface and said first housing portion manually pulled in a lengthwise manner to lay the strip of tape upon the surface, wherein the strip of tape is selectively cut by said cutter.

2. A tape dispenser apparatus according to claim 1 further comprising a second housing portion that is removably engaged to said first housing portion such that said roller, said cutter in said retracted state, and said means for urging are completely enclosed being isolated from a user's hands for safety.

3. A tape dispenser apparatus according to claim 2 further comprising a protrusion disposed upon said second housing portion positioned opposite of said hub, wherein said protrusion is operationally in slidable contact with the surface that the tape does not lay the strip of tape on, with said protrusion acting as a gauge to set a distance of the tape strip from the non-tape strip surface.

4. A tape dispenser apparatus according to claim 1 wherein said means for urging is in the form of a spring.

5. A tape dispenser apparatus according to claim 1 wherein said cutter is in the form of a wire with a leading edge, wherein said leading edge is blunt for user safety.

6. A tape dispenser apparatus according claim 5 wherein said cutter further comprises an extension that projects therethrough an extension aperture in said first housing portion to further enable said cutter to be manually selectively placed in said cutting state.

7. A tape dispenser apparatus kit utilizing a roll of tape with adhesive on one side of the tape for applying a strip of tape from the roll of tape to a surface that is adjacent to another surface that is perpendicularly oriented, comprising:
(a) a tape dispenser apparatus including a first housing portion including a hub for rotatably supporting the roll of tape, wherein the tape rotates about a first rotational axis, said first housing portion also includes a tape aperture feeding into a tape channel that acts as a guide for the strip of tape, further said first housing portion includes a cutter aperture disposed within said channel, further said first housing includes a cutter pivotally attached to said first housing portion, wherein said cutter extends therethrough said cutter aperture in a cutting state and said cutter retracts from said cutter aperture being disposed within said first housing portion in a retracted state, wherein said cutter can be selectively placed in said cutting state, further included is a spring for urging said cutter into said retracted state and a roller that is attached to said first housing portion, wherein said roller is cylindrically positioned about a roller axis that is parallel to said first rotational axis and said roller is positioned such that it is proximate to a non-adhesive side of the tape, further included is a second housing portion that is removably engaged to said first housing portion such that said roller, said cutter in said retracted state, and said spring for urging are completely enclosed being isolated from a user's hands for safety, further included is a protrusion disposed upon said second housing portion positioned opposite of said hub, wherein operationally said roller routes the strip of tape off of the roll of tape around said cutter to feed the strip of tape into said tape aperture and tape channel, wherein operationally said tape channel is manually positioned adjacent to the surface and said first housing portion manually pulled in a lengthwise manner to lay the strip of tape upon the surface, wherein the strip of tape is selectively cut by said cutter, further said protrusion operationally is in slidable contact with the surface that the tape does not lay the strip of tape on, with said protrusion acting as a gauge to set a distance of the tape strip from the non-tape strip surface; and
(b) a forming ball having a radius sized in conjunction with said protrusion, wherein operationally said forming ball shapes a caulking material into a smooth fillet in-between the surfaces.

8. A tape dispenser apparatus kit according to claim 7 wherein said radius is sized to be substantially equal to a height of said protrusion away from said first housing portion.

9. A tape dispenser apparatus kit according to claim 8 further including a roll of tape.

10. A tape dispenser apparatus kit according to claim 8 further including caulking material.

11. A method of forming, smoothing, and setting a bead of caulking material between two surfaces that form a corner between one another, comprising the steps of:
(a) providing a tape dispenser apparatus that includes a first housing portion including a hub for rotatably supporting the roll of tape, wherein the tape rotates about a first rotational axis, said first housing portion also includes a tape aperture feeding into a tape channel that acts as a guide for a strip of tape, further said first housing portion includes a cutter aperture disposed within said channel, also included is a cutter pivotally attached to said first housing portion, wherein said cutter extends therethrough said cutter aperture in a cutting state and said cutter retracts from said cutter aperture being disposed within said first housing portion in a retracted state, wherein said cutter can be selectively placed in said cutting state via an extension, further included is a spring for urging said cutter into said retracted state and a roller that is attached to said first housing portion, wherein said roller cylindrically positioned about a roller axis that is parallel to said first rotational axis and said roller is positioned such that it is proximate to a non-adhesive side of the tape, further included is a second housing portion that is removably engaged to said first housing portion such that said roller, said cutter in said retracted state, and said spring for urging are completely enclosed being isolated from a user's hands for safety, further included is a protrusion disposed upon said second housing portion positioned opposite of said hub, wherein operationally said roller routes the strip of tape off of the roll of tape around said cutter to feed the strip of tape into said tape aperture and tape channel, wherein operationally said tape channel is manually positioned adjacent to the surface and said first housing portion manually pulled in a lengthwise manner to lay the strip of tape upon the surface, wherein the strip of tape is selectively cut by said cutter, further said protrusion operationally is in slidable contact with the surface that the tape does not lay the strip of tape on, with said protrusion acting as a gauge to set a distance of the tape strip from the non-tape strip surface;
(b) providing a forming ball;
(c) providing tape;
(d) providing caulking material;
(e) loading said tape into said tape dispenser apparatus;
(f) feeding the strip of tape around said roller to circumvent said cutter, further feeding the strip of tape through said tape aperture, and into said tape channel such that the tape adhesive side faces outward;
(g) positioning said protrusion against one of the surfaces;
(h) positioning said tape channel adjacent to the other surface;
(i) pulling said tape dispenser apparatus lengthwise against the surfaces such that said protrusion slides along one of the surfaces and the tape strip is applied to the other surface;
(j) engaging said cutter by manually placing said cutter into said cutting state via pushing said extension and cutting the strip of tape;
(k) repeating steps “g, h, i, and j” except that the surfaces are reversed, wherein the tape strip is applied to the surface is was not previously applied to by pulling said tape dispenser apparatus lengthwise against the surfaces in the opposite direction;
(l) applying caulking material to the corner to form a lengthwise bead of raw caulking material bead that overlaps onto the tape strips;
(m) sliding said forming ball lengthwise adjacent to the corner forming a smooth fillet of caulking material; and
(n) removing the tape strips from both surfaces leaving an even edged smooth filet of caulking material.
